(19) United States
(12) Patent Application Publication
(10) Pub. No.: US 2025/0291909 A1
(43) Pub. Date: Sep. 18, 2025

(54) DYNAMIC DIGITAL WATERMARKING SYSTEM FOR REAL-TIME USER ACTIVITY FINGERPRINTING AND UNAUTHORIZED ACCESS TRACKING

(71) Applicant: Leptude, Inc., Austin, TX (US)

(72) Inventor: John A. Fortkort, Austin, TX (US)

(21) Appl. No.: 19/080,928

(22) Filed: Mar. 16, 2025

Related U.S. Application Data
(60) Provisional application No. 63/566,276, filed on Mar. 16, 2024.

(51) Int. Cl. G06F 21/55

(52) U.S. Cl. CPC G06F 21/554; G06F 2221/034

(57) ABSTRACT

A method is provided for dynamically generating a digital watermark for a data file. The method includes receiving a request to access the data file from a user; dynamically generating an encryption key based on at least one parameter selected from the group consisting of the identity of the user, the time of access, and the mode of access; embedding a digital watermark into the data file using the dynamically generated encryption key, wherein the digital watermark is unique to the request; providing access to the data file with the embedded digital watermark to the user; and storing information related to the encryption key and the parameters used for its generation in a secure database.

### CROSS-REFERENCE TO RELATED APPLICATIONS

This application claims the benefit of U.S. provisional application No. 63/566,276 filed Mar. 16, 2024, having the same title and the same inventor, and which is incorporated herein by reference in its entirety.

### FIELD OF THE DISCLOSURE

The present disclosure relates generally to the field of digital data security and protection, and more specifically to systems and methods for enhancing the security and traceability of digital files through the dynamic generation and embedding of digital watermarks.

### BACKGROUND OF THE DISCLOSURE

Various problems currently exist in the realm of digital security, content management and data integrity. One common issue in this realm is the lack of specific traceability. In particular, difficulties currently exist in tracing unauthorized access or leaks back to their source. In this respect, it is notable that traditional static watermarks can indicate the intended recipient or owner but cannot provide specific details about when or how a file was accessed or leaked.

Many existing security measures are inflexible. For example, security systems are known that use rigid methods that do not adapt to the context of access, making it challenging to balance security with usability. Fixed encryption keys or watermarks do not account for the dynamic nature of data access and sharing in real-world environments.

Many existing security systems also fail to fully leverage available data about user interactions to enhance security measures. In [particular, while some systems track or analyze user behavior, they do not integrate this information into security mechanisms like watermarking in a dynamic, context-aware manner.

U.S. Pat. No. 7,359,881 (“System and Method for Watermarking Digital Images”) describes a method for embedding watermarks in digital images, potentially including copyright information, creator details, or other identifiers. However, it primarily focuses on the technical aspects of embedding and concealing watermarks within images. It does not address the problem of specific traceability and context-aware security.

U.S. Pat. No. 8,713,442 (“Methods, Systems, and Media for Masquerade Attack Detection by Monitoring Computer User Behavior”) details a system for detecting unauthorized access by monitoring user behavior, such as keystroke dynamics or mouse movements. While it leverages user-specific data for security, its focus is on detecting masquerade attacks rather than preventing data leaks or tracing data access back to its source through watermarking. It addresses the monitoring of user behavior but does not integrate this information into a dynamic, context-aware watermarking system.

### BRIEF DESCRIPTION OF THE DRAWINGS

FIG. 1 is an illustration of an embodiment of a process that may be utilized to determine the source of a leaked confidential document.

FIG. 2 is an illustration of a system for protecting sensitive documents.

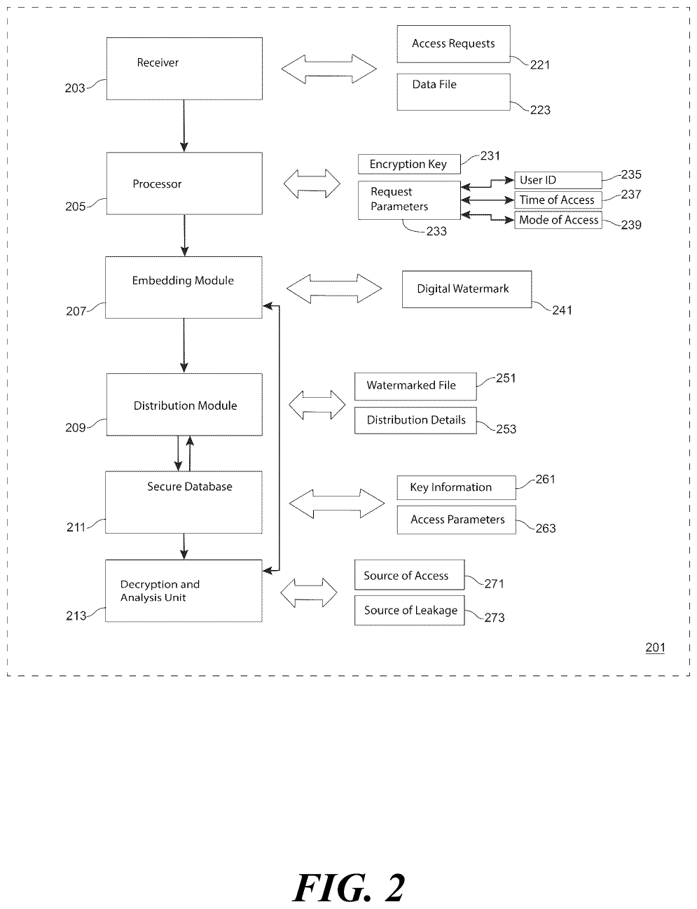

FIG. 3 is an illustration of a system for dynamic watermarking of digital files in a digital artwork distribution network on a blockchain platform.

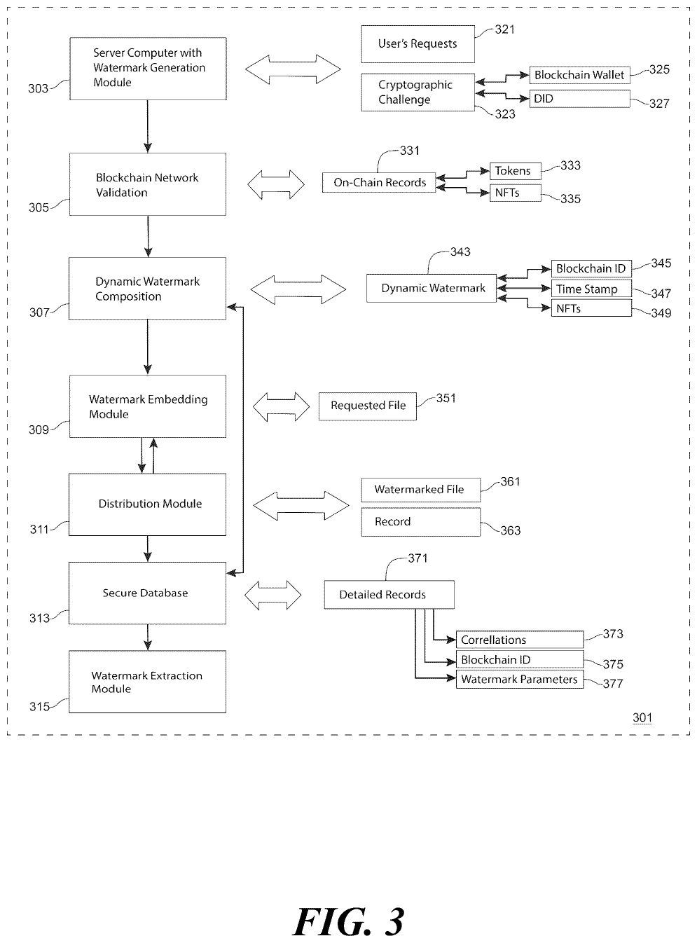

FIG. 4 is an illustration of a system for securing digital art on a platform and enforcing consequences for users who leak or redistribute files without authorization.

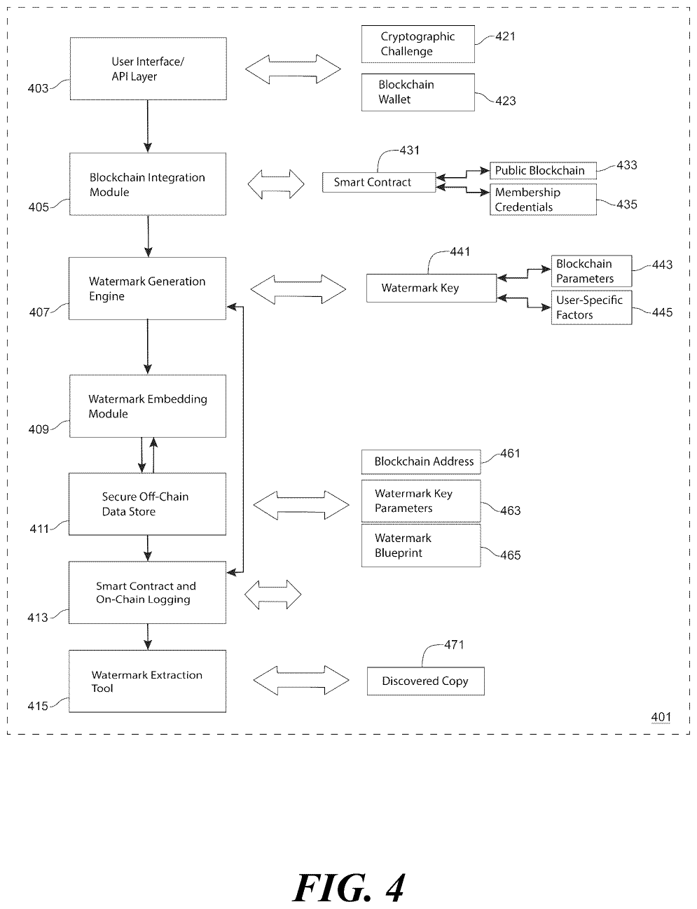

### SUMMARY OF THE DISCLOSURE

In one aspect, a method is provided for dynamically generating a digital watermark for a data file. The method comprises (a) receiving a request to access the data file from a user; (b) dynamically generating an encryption key based on at least one parameter selected from the group consisting of the identity of the user, the time of access, and the mode of access; (c) embedding a digital watermark into the data file using the dynamically generated encryption key, wherein the digital watermark is unique to the request; (d) providing access to the data file with the embedded digital watermark to the user; and (e) storing information related to the encryption key and the parameters used for its generation in a secure database.

In another aspect, a system is provided for identifying unauthorized access or leakage of a data file. The system comprises (a) a receiver configured to accept access requests for the data file; (b) a processor configured to dynamically generate an encryption key based on parameters of the access request, which include the identity of the user, the time of access, and the mode of access; (c) an embedding module configured to insert a digital watermark into the data file, utilizing the dynamically generated encryption key; (d) a distribution module configured to provide the watermarked data file to the user; (e) a secure database configured to store information pertaining to the generated encryption keys and their associated access parameters; and (f) a decryption and analysis unit configured to decrypt and examine the digital watermark to determine the source of access or leakage in the event of unauthorized distribution.

In a further aspect, a non-transitory computer-readable medium is provided containing instructions that, when executed by a processor, perform a method for tracking unauthorized distribution of a data file, the method comprising: (a) receiving a request to access the data file; (b) generating a unique encryption key based on the request parameters; (c) embedding a digital watermark into the data file using the unique encryption key; (d) providing the watermarked data file to the requester; and (e) in case of unauthorized distribution, decrypting the digital watermark to identify the source based on the encryption key and access parameters.

### DETAILED DESCRIPTION

Systems and methodologies are disclosed herein for dynamically generating a digital watermark for a data file, which watermark incorporates unique aspects of user interaction, such as the identity of the user, the time of access, and the mode of access, into the watermark creation process. This approach addresses several problems in the realm of digital security and data integrity that are not fully resolved by existing prior art.

Preferred embodiments of the systems and methodologies disclosed herein integrate dynamic watermarking with encryption and user-specific data to create a more secure, traceable, and flexible system for managing and protecting digital files. By generating encryption keys and watermarks based on real-time access parameters, these systems and methodologies offer specific traceability, allowing for the precise identification of the source of unauthorized access or leaks. They also provide significant advancements over static watermarking techniques by incorporating context-aware security measures that adapt to each instance of file access, enhancing the ability to trace and manage digital content securely.

Furthermore, by embedding these dynamically generated watermarks into data files, the system ensures that each file's security markings are unique to each access event, thereby offering a higher level of detail for forensic analysis in the event of unauthorized sharing or leaks. This approach also makes the security system more flexible and user-friendly, as it can adapt to legitimate access scenarios while still providing robust protection against unauthorized use.

The systems and methodologies disclosed herein address the limitations of the prior art by offering a novel solution that integrates dynamic, user-specific watermarking with encryption to enhance traceability, security, and flexibility in managing digital files. This provides a significant improvement in the ability to prevent, detect, and trace unauthorized data access and distribution.

### Example 1

This particular, nonlimiting example illustrates the use of the methodology disclosed herein to enhance data security in a corporate network by adding a layer of traceability to sensitive documents, thereby deterring unauthorized sharing and providing a clear means to investigate leaks when they occur.

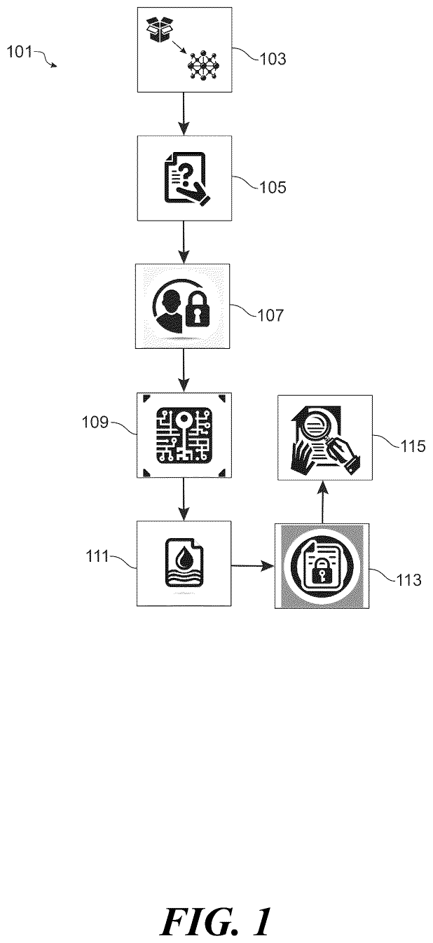

Consider a scenario where the inventive methodology is implemented in a corporate network environment to protect sensitive documents, such as financial reports, product designs, or strategic plans. The goal is to ensure that if any of these documents are accessed without authorization or leaked, they can be traced back to the source of the leak. FIG. 1 depicts a particular, non-limiting embodiment of a step-by-step process 101 of how such an approach may be implemented.

Step 1: Integration into the Corporate Network

As a preliminary matter, the watermarking system disclosed herein is integrated 103 with the corporate network's existing security infrastructure, including user authentication systems and access control mechanisms. This ensures that the dynamic watermarking process can leverage real-time data about user identities, access times, and modes of access.

### Step 2: Document Request and User Authentication

When an employee (or an authorized user) requests access 105 to a sensitive document, the system authenticates the user's identity 107 using the corporate network's standard authentication processes. This might involve a combination of username/password, multi-factor authentication, or biometric verification.

### Step 3: Dynamic Encryption Key and Watermark Generation

Upon successful authentication, the system dynamically generates an encryption key 109 for the document. This key is unique for each access request and is generated based on a combination of parameters, including the user's identity, the current time, and the mode of access (e.g., through a web interface, from a specific device, etc.).

Using this encryption key, a digital watermark is embedded 111 into the requested document. This watermark is invisible during normal use (e.g., viewing, editing) but can be extracted and decrypted by the system if necessary.

### Step 4: Document Access

The watermarked document is then made available to the user during document access 113. The system logs the access event, including the parameters used to generate the encryption key and watermark, in a secure database for future reference.

### Step 5: Monitoring and Response

The system then monitors 115 places external to the corporate network or unauthorized locations. If a watermarked document is found outside the corporate network or in an unauthorized location, the system can extract and decrypt the watermark to identify the specific access event that led to the document being compromised.

The secure database is queried to retrieve the access log corresponding to the watermark, which includes the user's identity, the time of access, and the mode of access, allowing security personnel to trace the leak back to its source.

### Example 2

This particular, nonlimiting example illustrates the implementation of the methodology of EXAMPLE 1 in protecting financial reports.

A financial analyst needs to access the quarterly financial report for analysis. They log in to the document management system and request the report. The system authenticates the analyst's identity, then dynamically generates an encryption key based on their user ID, the access time (e.g., “March 3, 2024, 10:15 AM”), and the mode of access (e.g., “desktop application”).

A digital watermark, encrypted with the generated key, is embedded into the financial report. The report is then provided to the analyst for their use. The access event, including all parameters and the unique watermark, is logged.

Later, if a copy of this report is found on an unauthorized external platform, the embedded watermark can be decrypted to reveal the access details, pinpointing the source of the leak for further investigation.

### A. Encryption Key Watermarking

Systems and methodologies of the type described herein which implement watermarking with a dynamically generated encryption key leverage cryptographic techniques to embed secure, traceable watermarks into digital content. Such systems and methodologies are particularly suitable for protecting intellectual property, ensuring content authenticity, and tracing unauthorized distribution. The dynamic nature of the encryption key generation ensures that each watermark is unique and tied to specific access or distribution contexts, enhancing security and traceability. Here's a detailed breakdown of such a system:

One particular, non-limiting embodiment of a system that may be utilized to implement the foregoing methodology may include a key generation module, a watermark generator, a content embedding tool, a content analysis module, a watermark extraction and decryption tool, a secure database, and a distribution monitoring system. These components are described in greater detail below.

The key generation module dynamically generates unique encryption keys for watermarking based on predefined criteria such as, for example, user identity, content type, access time, and other contextual information. This module utilizes cryptographic algorithms to ensure that each key is secure and unique. The watermark generator creates a digital watermark for the content. This watermark can include various types of information such as, for example, the content ID, timestamp, user ID, and other relevant metadata. The watermark is then encrypted using the dynamically generated key to enhance security. The content embedding tool integrates the encrypted watermark into the digital content. Depending on the type of content (e.g., text, image, audio, video), the tool applies different techniques to embed the watermark in a way that minimizes perceptual impact while ensuring robustness against removal or tampering. The content analysis module analyzes the content to determine the most suitable areas for watermark embedding, focusing on regions that are least likely to be altered and that minimally affect the content's perceptibility and quality. The watermark extraction and decryption tool detects, extracts, and decrypts (when necessary) the embedded watermark from the content, using the appropriate encryption key. This process is important for verifying content authenticity, tracing unauthorized distribution, and enforcing digital rights management policies. The secure database stores records of generated encryption keys, watermarks, and associated content and user information. This database is important for managing the watermarking process and supporting content verification and tracking. The distribution monitoring system tracks the distribution of watermarked content across various platforms and channels, logging each instance of access, sharing, or downloading. This system aids in identifying potential leaks and tracing unauthorized distributions back to their source.

A particular, non-limiting example of an embodiment of a process flow for a system incorporating the foregoing components features the steps of encryption key generation, watermark creation and encryption, watermark embedding, content distribution, and watermark extraction and verification. These steps are described in greater detail below.

### 1. Encryption Key Generation

In the encryption key generation step, each time content is accessed or prepared for distribution, the key generation module creates a unique encryption key based on the specific context of the access or distribution event. The key encryption step in a digital watermarking system of the type disclosed herein is important for ensuring the security and integrity of the watermarking process. This step preferably involves generating a unique encryption key for each instance of watermark embedding, which encrypts the watermark before it is embedded into the content. The encryption of the watermark adds a layer of security, making the watermark difficult to tamper with or remove without authorization.

The key encryption process preferably involves the steps of key generation, encryption algorithm selection, watermark encryption, and key management. These steps are defined in greater detail below.

The process begins with key generation (that is, the generation of a unique encryption key). This key may be generated based on various parameters including, for example, user ID, content ID, timestamp, and potentially other contextual information to ensure uniqueness. Cryptographically secure pseudorandom number generators (CSPRNGs) may be utilized for this purpose.

In the subsequent encryption algorithm selection, a cryptographic algorithm is selected for encrypting the watermark. Possible choices may include AES (Advanced Encryption Standard), RSA, or ECC (Elliptic Curve Cryptography), depending on the required level of security and performance considerations. Here, it is noted that AES is widely used in other applications for its balance of security and efficiency, RSA for its public-key encryption capabilities, and ECC for providing similar levels of security as RSA but with smaller key sizes, which can be advantageous in reducing the size of a watermark.

In the watermark encryption step, the generated watermark, which contains the digital information to be embedded into the content, is encrypted using the selected algorithm and the unique encryption key. This encrypted watermark is then ready to be embedded into the digital content. In the key management step, the encryption key, along with information about the encryption algorithm and parameters used for key generation, is securely stored for later use during the watermark extraction and verification process. Key management practices are important to ensure the security of the encrypted watermarks and the integrity of the overall system.

For enhanced security, hardware security modules (HSMs) may be used during the key generation and encryption process. HSMs are physical devices that provide secure generation, storage, and management of encryption keys. They are designed to be resistant to tampering and unauthorized access, making them ideal for sensitive operations like key generation for watermark encryption. Several well-established cryptographic libraries may be utilized for implementing the encryption algorithms. Libraries such as OpenSSL, Crypto++, and Bouncy Castle offer a wide range of cryptographic functions, including secure key generation and support for various encryption algorithms. These libraries are maintained by security experts and are regularly updated to address new vulnerabilities and security threats. Some embodiments of the systems and methodologies disclosed herein may also utilize cloud-based cryptography services. In such embodiments, cloud providers such as AWS, Google Cloud, and Microsoft Azure may be leveraged for cryptography services (e.g., AWS KMS, Google Cloud KMS, Azure Key Vault) that may be used for key management and encryption tasks. These services provide a scalable, secure environment for key generation and encryption, with the added benefits of cloud storage and access management features.

### 2. Watermark Creation and Encryption

In the watermark creation and encryption step, the watermark generator creates a watermark incorporating relevant content and user metadata, which is then encrypted with the dynamically generated key.

The watermark creation and encryption steps are a pivotal part of the digital watermarking process, ensuring that the watermark is both unique to the content/user and securely embedded within the digital content. These steps involve generating a watermark based on specific attributes and then encrypting this watermark using cryptographic techniques.

Watermark creation preferably involves the steps of data aggregation, watermark encoding and error correction. Data aggregation typically involves collecting relevant data to be included in the watermark. This may include, for example, user ID, content ID, timestamp, access rights information, and potentially other metadata related to the content or user behavior. Watermark encoding typically includes converting the aggregated data into a format suitable for embedding within the content. This may involve encoding the data as a binary sequence or using more sophisticated encoding schemes to enhance robustness or imperceptibility. Error correction may involve applying error correction codes (ECC) to the encoded watermark. This step increases the resilience of the watermark to modifications, compression, and other forms of content processing. Reed-Solomon codes may be used for this purpose due to their strong error correction capabilities. Watermark encryption preferably involves the steps of key generation, selection of an encryption algorithm, and watermark encryption. Key generation involves the generation of a unique encryption key for the watermark. This key may be derived, for example, from a combination of the watermark data itself and other contextual information, ensuring uniqueness.

Cryptographically secure pseudorandom number generators (CSPRNGs) may be utilized here, and the use of hardware security modules (HSMs) may provide an additional layer of security by generating and storing keys in a tamper-resistant environment. Selection of a suitable encryption algorithm typically involves choosing one of several known encryption algorithms. Preferably, AES (Advanced Encryption Standard) is used for this purpose, given its strong security and efficiency. However, in embodiments requiring public-key infrastructure (PKI), RSA or ECC may be chosen. Watermark encryption typically involves use of the selected encryption algorithm to encrypt the watermark, transforming it into a secure, non-readable format that can only be decrypted with the corresponding key.

### 3. Watermark Embedding

In the watermark embedding step, the content embedding tool integrates the encrypted watermark into the content, guided by the content analysis module to ensure optimal placement and minimal impact on content quality. The watermark embedding step is where the previously created and encrypted watermark is integrated into the digital content, marking it in a way that is ideally imperceptible to users but detectable through specific analysis tools. This step is important for maintaining the original content's integrity and usability while embedding the watermark securely.

The watermark embedding process preferably involves the steps of content analysis, watermark integration, quality assurance, and finalization. These steps are described in greater detail below.

Content analysis refers to the initial process of analyzing the content to identify the most suitable areas or channels for embedding the watermark. This typically involves determining parts of the content where alterations can be made without perceptibly affecting its quality. For images and videos, this may involve selecting regions with high visual complexity; for audio files, segments less audible; and for documents, spaces or formats that are less noticeable.

Watermark integration involves the actual embedding of the watermark into the content using the chosen method. This will typically vary based on the content type. Thus, for images and videos, techniques such as least significant bit (LSB) insertion, discrete cosine transform (DCT), or discrete wavelet transform (DWT) may be utilized. For audio, suitable methods may include echo hiding, phase coding, or spread spectrum. For text documents, watermarking may be achieved through formatting changes, word or sentence spacing adjustments, or invisible character insertion.

After embedding the watermark, a quality assurance check is performed to ensure that the content's perceptual quality has not been compromised. This may involve automated software checks or user panels for subjective assessment. In the finalization step, the watermarked content is encoded or saved in its final format, ensuring that the watermark remains intact through the encoding process.

Various hardware and software products may be utilized in the implementation of the watermark embedding step. For real-time or high-performance watermarking applications, dedicated DSP hardware may be utilized to accelerate the analysis and transformation of content (especially audio and video) for watermark embedding. Graphical processing units (GPUs) may be utilized to significantly speed up the watermark embedding process for images and videos, thanks to their ability to perform parallel computations efficiently. Various software tools and libraries are specialized in digital watermarking, offering pre-built functions for embedding watermarks in different types of content. Nonlimiting examples include OpenPuff for multimedia, Steghide for images and audio files, and proprietary software solutions tailored to specific industries. For custom watermark embedding solutions, libraries such as OpenCV for image and video processing, Librosa for audio processing, and iText or Apache PDFBox for PDF documents may be utilized. These libraries allow developers to manipulate content and embed watermarks programmatically. It will be appreciated that, by carefully selecting the appropriate techniques and technologies for the watermark embedding process, it is possible to achieve a balance between imperceptibility, robustness, and efficiency, ensuring that digital content is securely marked without compromising its quality or usability.

### 4. Content Distribution

In the content distribution step, the watermarked content is distributed to authorized users or platforms, with the distribution monitoring system tracking each transaction and logging detailed information for future reference. The content distribution step involves securely and efficiently delivering the watermarked digital content to its intended audience while maintaining the integrity of the watermark and tracking the distribution for rights management and unauthorized distribution detection. This process is important for content creators, distributors, and platforms that rely on digital content dissemination.

The content distribution process will preferably involve the steps of preparation for distribution, the use of a secure content delivery network (CDN), rights management and access control, distribution tracking and logging, and a feedback loop for quality and security monitoring. These elements are described in greater detail below. Preparation for distribution includes packaging the content in a format suitable for distribution. This may involve compression, format conversion, or bundling multiple files. It is essential to ensure that these processes do not degrade the embedded watermark. A CDN is then utilized to distribute the content globally. Use of a CDN ensures fast and reliable access to users regardless of their location. CDNs can also provide added layers of security, such as SSL/TLS encryption, to protect the content during transmission. Rights management and access control implements digital rights management (DRM) systems to control access to the content based on a user's entitlements. This may involve encryption of the content itself, with keys provided only to authorized users, or the use of token-based authentication systems. Distribution tracking and logging involves the maintenance of detailed logs of content distribution events, including user information, access times, and geographic locations. This data is important for monitoring distribution patterns and identifying potential unauthorized sharing. The feedback loop for quality and security monitoring implements systems to gather user feedback on content quality and monitor for potential security breaches or unauthorized distribution attempts. This feedback may help in adjusting distribution strategies and enhancing content protection measures.

Various hardware and software products may be utilized in the content distribution step. In terms of CDNs, providers such as Akamai, Cloudflare, and Amazon CloudFront offer robust, scalable solutions for content distribution. These platforms provide extensive global coverage, ensuring that content is delivered quickly and reliably to users worldwide.

Various digital rights management (DRM) solutions may be utilized in the content distribution step. Software solutions such as, for example, Microsoft PlayReady, Google Widevine, and Apple FairPlay provide DRM capabilities, allowing for the secure encryption of content and management of user access rights.

Various content management systems (CMSs) may be utilized in the content distribution step. For example, platforms such as WordPress (with appropriate plugins), Drupal, and custom-built CMS solutions may facilitate the distribution of watermarked content, especially for text and images, providing tools for content organization, user management, and analytics.

Various distribution and analytics platforms may be utilized in the content distribution step. For example, tools such as Google Analytics, Adobe Analytics, and custom analytics solutions built on platforms like AWS or Google Cloud may be utilized to track content distribution metrics, and to provide insights into user engagement, content reach, and potential unauthorized distribution.

Various encryption and network security hardware and software products may be utilized in the content distribution step. For example, SSL/TLS encryption may be utilized for content transmission, and hardware security modules (HSMs) may be utilized for secure key management. Firewalls and anti-DDoS tools may be used to protect the distribution infrastructure from attacks.

### 5. Watermark Extraction and Verification

In the watermark extraction and verification step, if there is a need to authenticate the content or investigate its distribution, the watermark extraction and decryption tool retrieves, decrypts, and analyzes the watermark to extract the embedded information, which is then compared against records in the secure database. The watermark extraction process preferably involves the steps of detection, extraction, decryption and verification. These steps are described in greater detail below.

The detection step involves detecting the presence of a watermark within the digital content. This typically requires analyzing the content for patterns or modifications indicative of watermarking. The specific detection technique depends on the type of watermarking used (e.g., LSB for images, spread spectrum for audio). Once detected, the watermark is extracted from the content. The extraction process typically involves reversing the embedding process to retrieve the watermark data, which may be encrypted. A decryption step may be necessary if the watermark was encrypted (as is often the case for security reasons). This step involves decrypting the extracted watermark using the appropriate key. This step is important for accessing the watermark data in its original form. The verification step involves verifying the decrypted watermark against a database of known watermarks or checked for integrity based on expected patterns or data. This may involve matching the watermark to a specific user, content ID, or timestamp to confirm content authenticity and trace its distribution.

In terms of hardware and software products that may be utilized in the content distribution step, for real-time applications or large-scale content verification, Digital Signal Processing (DSP) hardware may be utilized to accelerate the analysis of content for watermark detection and extraction, particularly for audio and video content. Graphics Processing Units (GPUs): GPUs are beneficial for processing large datasets or high-resolution content, such as images and videos, where watermarks need to be detected and extracted efficiently. For the decryption of watermarks, cryptographic libraries such as OpenSSL, Crypto++, or Bouncy Castle are essential. They provide robust algorithms for decrypting the watermark data securely. Systems such as MySQL, PostgreSQL, or MongoDB may be leveraged for storing, managing, and querying watermark data and associated metadata, it being noted that fast access and retrieval may be important for efficient verification. Finally, watermarking tools, which are specialized software tools designed for watermark detection and extraction, may be important components for implementing watermark extraction and verification. These may be proprietary solutions tailored to specific watermarking techniques or open-source tools with broad applicability.

By leveraging dynamically generated encryption keys, this system provides a highly secure and versatile approach to watermarking digital content, enhancing the ability to protect intellectual property, verify content authenticity, and trace unauthorized distribution.

Preferred embodiments of the foregoing systems and methodologies ensure the security of the encryption keys and the privacy of user and content information, adhering to relevant data protection regulations. The watermark embedding technique is preferably resilient to various forms of content manipulation and compression, while also being imperceptible to ensure it does not degrade the content's quality. The system is preferably capable of efficiently processing large volumes of content, with quick key generation, watermark embedding, and extraction processes. The system should also accommodate various types of digital content, with techniques for embedding and extracting watermarks tailored to each content form.

### B. Metadata-Based Watermarking

Various embodiments of systems and methodologies are possible in accordance with the teachings herein which do not involve, or rely upon, the use of encryption keys for watermarking. For example, some embodiments of the systems and methodologies disclosed herein may utilize metadata-based watermarking. Such embodiments will preferably involve embedding a watermark into the metadata of a file, and dynamically adjusting the watermark based on user-specific and contextual information. For instance, a unique identifier may be generated using the user's access time, device ID, and network location, and then encoded into the metadata fields of a file such as, for example, in the comments, author, or creation date fields. This approach allows for tracking without altering the actual content of the file.

One particular, non-limiting embodiment of a system that may be utilized to implement the foregoing methodology may include a user authentication module, an access request handler, a unique identifier generator, a metadata embedding tool, a metadata reading tool, a secure database, and a file distribution monitor. These components are described in greater detail below.

The user authentication module verifies the identity of users requesting access to digital files. It preferably integrates with existing authentication mechanisms, such as LDAP or OAuth, to ensure that only authorized users can access and modify files. The access request handler processes requests to access digital files. This component logs the details of each request, including the user's identity, time of access, and mode of access (e.g., through a web portal, desktop application, etc.). The unique identifier generator creates a unique identifier (UID) for each file access request. The UID may be generated based on a combination of the user's identity, access time, mode of access, and possibly other contextual information (e.g., IP address, device ID). This component may use algorithms to ensure that each UID is unique and can include hashing functions for additional security. The metadata embedding tool embeds the generated UID into the metadata of the requested file. This tool is preferably capable of modifying various metadata fields that are typically unused or overlooked, such as “Comments,” “Last Printed Date,” “Template Information,” or custom-defined fields. The tool ensures that the embedding process does not alter the file's content or affect its usability. The metadata reading tool extracts and interprets the UID from the file's metadata. This tool is used when there is a need to trace a file's distribution or verify its authenticity. It decrypts the UID if necessary and retrieves the associated access details from the secure database. The secure database stores detailed logs of file access requests, including the generated UIDs and the parameters used for their generation. The database is protected by robust security measures to prevent unauthorized access and ensure the integrity of the stored data. The file distribution monitor is an optional component which monitors the distribution of watermarked files. This monitor scans for copies of the files on unauthorized platforms or locations and uses the metadata reading tool to identify the source of leaked files.

A particular, non-limiting example of an embodiment of a process flow for a system incorporating the foregoing components features the steps of authentication, access logging, UID generation, metadata encoding, file access, UID storage, and monitoring and verification. In the authentication step, a user requests access to a digital file, and the user authentication module verifies their identity. In the access logging step, the access request handler logs the request details. In the UID generation step, the unique identifier generator creates a UID based on the access request's parameters. In the metadata embedding step, the metadata embedding tool embeds the UID into the file's metadata in selected fields. In the file access step, the modified file is provided to the user, now containing a unique digital watermark in its metadata. In the UID storage step, information about the generated UID and the access request is securely stored in the database. In the monitoring and verification step (if applicable), the file distribution monitor tracks the distribution of the watermarked file, and the metadata reading tool can extract UIDs from files to trace their origin or verify their authenticity.

The foregoing embodiment offer a comprehensive solution for metadata-based watermarking, providing a means for secure and traceable distribution of digital files. One skilled in the art will appreciate that the system will preferably be compatible with various file formats and types, requiring adaptability in how metadata is read and written. Security measures will preferably be utilized to protect the integrity of the watermarks and the privacy of user data. The system is also preferably scalable and efficient, and thus is capable of handling a large volume of file access requests without significant delays.

### C. Stenographic Techniques

In other embodiments of the systems and methodologies disclosed herein, stenographic techniques may be utilized to hide information within the file in a way that does not require encryption but is not easily detectable to the naked eye or by standard file analysis. For digital images, this may mean, for example, subtly changing pixel values; for audio files, it may involve slight variations in sound frequency. The specific variations may be determined based on the identity or access context of the user and may be decoded to retrieve the watermark.

A system that utilizes steganographic techniques for watermarking digital content involves embedding a unique watermark into the content in such a way that it is imperceptible to users but can be detected and extracted with the appropriate tools. This system may be particularly useful for copyright protection, content authentication, and tracking unauthorized distribution of digital media, including images, audio, video, and documents.

One particular, non-limiting embodiment of a system that may be utilized to implement the foregoing methodology includes a content processing module, a watermark generator, a stenographic embedding tool, a content distribution handler, a watermark extraction tool, a verification and tracking system, and a secure database. These components are described in greater detail below.

The content processing module prepares digital content for watermarking. It identifies suitable areas within the content where watermarks may be embedded with minimal impact on perceptual quality. For images and videos, this may involve selecting regions with sufficient complexity; for audio, segments with varying frequencies; and for documents, spaces within text or images contained within the document. The watermark generator creates a unique watermark for each piece of content. This may involve generating a code based on content-specific parameters (such as, for example, content ID, creator ID, and timestamp) and possibly user-specific parameters (such as, for example, user ID or access details). The steganographic embedding tool embeds the generated watermark into the content using steganographic techniques. This tool is preferably capable of altering the content at a bit-level, such as modifying the least significant bits (LSBs) of image pixels, inserting imperceptible echoes or phase coding in audio files, or subtly altering video frame pixels, in a way that does not perceptibly degrade the content quality. The content distribution handler manages the distribution of watermarked content, ensuring that each recipient receives a uniquely watermarked version of the content. This component also logs distribution details for tracking purposes. The watermark extraction tool extracts the watermark from content for verification purposes. This tool may be used to detect the presence of a watermark in a piece of content and decode the watermark to retrieve the embedded information. The verification and tracking system compares extracted watermarks with a database of issued watermarks to verify the authenticity of content and track its distribution. This system can identify unauthorized copies of content and potentially trace them back to the original recipient or source of leakage. The secure database stores information about each piece of content, the corresponding generated watermarks, and distribution logs. This database is essential for managing watermarks, verifying content authenticity, and investigating instances of unauthorized distribution.

A particular, non-limiting example of an embodiment of a process flow for a system incorporating the foregoing components features the steps of content preparation, watermark creation, steganographic embedding, content distribution, watermark extraction, and verification and tracking. These steps are described in greater detail below.

In the content preparation step, the content processing module analyzes digital content to identify optimal regions for watermark embedding. In the watermark creation step, the watermark generator creates a unique watermark for the content, which may include encoding specific information about the content, creator, or user. In the steganographic embedding step, the steganographic embedding tool embeds the watermark into the content, altering it in a subtle, imperceptible manner. In the content distribution step, the content distribution handler distributes the watermarked content to users or recipients, logging each distribution event. In the watermark extraction step, the watermark extraction tool (when necessary) can detect and decode the watermark from the content to verify its authenticity or trace its distribution. In the verification and tracking step, the verification and tracking system uses the extracted watermark information to authenticate content and monitor its distribution, comparing it against the secure database.

Various considerations may be taken into account in the implementation of systems and methodologies for utilizing steganographic techniques for watermarking of digital content. These include imperceptibility (the system preferably ensures that the watermarking process does not perceptibly alter the content quality for the end-users); robustness (watermarks are preferably resilient to various forms of manipulation and degradation, such as compression, cropping, or format conversion); efficiency (the system is preferably capable of processing and watermarking content efficiently to handle large volumes of content without significant delays); and security (the system preferably secures the watermark information and distribution logs to prevent unauthorized access and ensure the privacy of user data). This system offers a robust solution for copyright protection, authentication, and tracking of digital content using steganographic watermarking techniques, ensuring content creators and distributors can protect and monitor their digital assets effectively.

### D. Behavioral Watermarking

In other embodiments of the systems and methodologies disclosed herein, behavioral watermarking may be utilized. This approach preferably generates watermarks based on the behavior of the user at the time of access. For example, behavioral parameters such as the speed of typing, mouse movements, or even the sequence of actions taken to access the file may be analyzed and abstracted into a unique behavioral pattern. This pattern, converted into a digital code, is then embedded into the file as a watermark.

One particular, non-limiting embodiment of a system that may be utilized to implement the foregoing methodology includes a behavioral data collection module, a behavioral pattern analysis engine, a watermark generator, a content embedding tool, a distribution tracking system, a watermark detection and extraction tool, and a secure database.

The behavioral data collection module captures real-time data on how users interact with digital content. This may include mouse movements, click patterns, typing rhythms, application usage patterns, and any other user-specific interactions that can be quantitatively measured. The behavioral pattern analysis engine analyzes the collected behavioral data to identify unique patterns or signatures that distinguish each user. This engine employs algorithms and machine learning techniques to process and convert behavioral data into a unique behavioral pattern or signature. The watermark generator utilizes the unique behavioral patterns identified by the analysis engine to generate a corresponding digital watermark. This watermark effectively encodes the behavioral pattern into a format that can be embedded into digital content or its metadata. The content embedding tool embeds the generated behavioral watermark into the digital content. Depending on the type of content, this embedding may be achieved through subtle modifications that do not perceptibly alter the content (for media files) or through the inclusion of unique identifiers in metadata or within the content itself (for documents and software). The distribution tracking system manages the distribution of watermarked content and logs detailed access and distribution events. This system ensures that each piece of distributed content is uniquely marked with the behavioral watermark of the user who accessed or created it. The watermark detection and extraction tool identifies and extracts the behavioral watermark from digital content. This tool may be essential for analyzing suspected cases of unauthorized content distribution, allowing for the tracing of content back to the original user based on their unique behavioral watermark. The secure database stores information related to user behavioral patterns, generated watermarks, and content distribution logs. Access to this database is strictly controlled to protect privacy and ensure the integrity of the watermarking system.

A particular, non-limiting example of an embodiment of a process flow for a system incorporating the foregoing components features the steps of behavioral data capture, pattern analysis and watermark generation, watermark embedding, content distribution, unauthorized distribution detection, and source identification. These steps are described in greater detail below.

In the behavioral data capture step, as users interact with digital content, the behavioral data collection module captures their interaction patterns in real time. In the pattern analysis and watermark generation step, the behavioral pattern analysis engine processes the collected data to identify unique behavioral patterns, which are then used by the watermark generator to create a digital watermark. In the watermark embedding step, the content embedding tool integrates the behavioral watermark into the digital content or its associated metadata, ensuring that each piece of content is uniquely marked. In the content distribution step, watermarked content is distributed to users, with the distribution tracking system logging the event and associating each piece of content with its unique behavioral watermark. In the unauthorized distribution detection step, if watermarked content is found in unauthorized locations, the watermark detection and extraction tool is used to identify and extract the behavioral watermark. In the source identification step, the extracted watermark is compared against the secure database to match it with a specific user's behavioral pattern, potentially identifying the source of unauthorized distribution.

The behavioral watermarking systems and methodologies disclosed herein offer a novel approach to protecting digital content by leveraging the unique interaction patterns of users, providing a mechanism for tracing unauthorized distribution.

Various considerations may be taken into account in implementing these systems and methodologies. For example, implementing behavioral watermarking requires careful consideration of privacy issues. Consent from users for collecting behavioral data and transparent policies on how data is used may be essential. The systems and methodologies utilized should also ensure that behavioral patterns are sufficiently unique and consistent to accurately identify individual users without false positives. The watermarking technique should be robust against attempts to modify or remove watermarks, requiring sophisticated detection and extraction tools. The system should also be scalable to handle large numbers of users and vast amounts of content, necessitating efficient data processing and storage solutions.

### E. Pattern-Based Watermarking

In still other embodiments of the systems and methodologies disclosed herein, pattern-based watermarking may be utilized. In this method, a unique pattern or sequence may be generated dynamically based on non-encryption parameters such as date, time of access, user ID, and other contextual data. This pattern may be embedded into the file through various means as, for example, by adding specific tags in document files, altering frame patterns in video files, or modulating audio patterns in sound files.

One particular, non-limiting embodiment of a system that may be utilized to implement behavioral-based watermarking includes a pattern generator, a content analysis module, a watermark embedding tool, a watermark extraction and verification tool, a user and content database, and a distribution tracker. These components are described in greater detail below.

The pattern generator creates a unique watermark pattern for each piece of content based on predefined criteria. This may involve algorithms that can incorporate user data, content metadata, timestamp information, and other relevant factors to ensure the watermark's uniqueness and relevance to the specific content and user. The content analysis module analyzes the content to identify optimal locations or methods for embedding the watermark pattern. For example, in an image, this may mean selecting areas with less visual focus; in audio files, segments with less auditory significance; and in documents, areas that are less likely to be altered by the user. The watermark embedding tool embeds the generated watermark pattern into the content. The embedding method varies with the content type and is designed to be imperceptible to users while ensuring the watermark remains intact through various forms of content manipulation and distribution. The watermark extraction and verification tool detects and extracts the watermark pattern from the content for authentication and tracing purposes. This tool preferably uses pattern recognition algorithms to identify the watermark within the content, even if the content has been altered or compressed. The user and content database stores user information, content metadata, and watermark patterns associated with each content piece. This database is essential for managing watermarks, facilitating the quick retrieval of information necessary for watermark generation, and verification. The distribution tracker monitors the distribution of watermarked content, logging access and sharing activities. This component is important for tracing unauthorized distribution and identifying potential breaches in content security.

A particular, non-limiting example of an embodiment of a process flow for a system incorporating the foregoing components features the steps of watermark pattern generation, content analysis, watermark embedding, content distribution, and watermark extraction and verification. These steps are described in greater detail below.

In the watermark pattern generation step, upon request for content access or distribution, the pattern generator creates a unique watermark pattern based on the specified criteria, ensuring the pattern is relevant and unique to the content and user. In the content analysis step, the content analysis module evaluates the content to determine the most suitable method and location for watermark embedding, ensuring minimal impact on content quality. In the watermark embedding step, the watermark embedding tool integrates the watermark pattern into the content. The embedding is done in such a way that it does not perceptibly alter the content for the end-user. In the content distribution step, once the watermark is embedded, the content is distributed to the intended recipient. The distribution tracker logs the event, including details about the user, content, and watermark pattern. In the watermark extraction and verification step, if there is a need to authenticate the content or trace its distribution, the watermark extraction and verification tool is used to detect and decode the embedded pattern, verifying the content's authenticity and identifying its source.

Various considerations may be taken into account in implementing these systems and methodologies. For example, the system should ensure that the embedded watermark does not perceptibly alter the content for the user, maintaining the original quality and usability of the content. The watermark should be resilient to various forms of manipulation, such as cropping, compression, and format conversion, ensuring it can still be detected after such transformations. The process of generating, embedding, and extracting watermarks must be efficient to handle large volumes of content without significant processing delays. The system should also implement robust security measures to protect the watermark information, user data, and content integrity, preventing unauthorized access and modification.

F. Content Hashing with Salt

Still other embodiments of the systems and methodologies disclosed herein may utilize content hashing with salt. In these embodiments, a unique hash of the file content may be generated, incorporating a “salt” that includes user-specific and access-specific information. This hash does not encrypt the file but serves as a unique identifier that changes with each access, embedding this hash within the file or its metadata as a watermark. The original content remains unchanged, and the watermark allows for tracing.

One particular, non-limiting embodiment of a system that may be utilized to implement the foregoing methodology includes a content analysis module, a salt generator, a hashing engine, a watermark embedding tool, a content distribution tracker, a watermark detection and extraction tool, and a verification database. These components are described in greater detail below.

The content analysis module analyzes the digital content to prepare it for the hashing process. This module assesses the content type (e.g., text, image, audio, video) and determines the most suitable data segments for hashing to ensure that the watermark does not affect the content's integrity or usability. The salt generator creates a unique salt for each piece of content based on various factors, such as user information, access time, content metadata, and other contextual parameters. The salt is designed to be unique for each instance of content access or distribution, enhancing the watermark's uniqueness. The hashing engine combines the digital content (or selected segments of it) with the generated salt to produce a unique hash value. This engine uses cryptographic hashing algorithms (e.g., SHA-256) to ensure that the hash is secure and virtually impossible to reverse-engineer. The watermark embedding tool embeds the generated hash (watermark) into the content or its metadata. The embedding method depends on the content type and is performed in a way that preserves the content's original quality and usability. For example, the hash could be embedded in the metadata of images or videos, in the audio spectrum of sound files, or within the document properties of text files.

The content distribution tracker monitors and logs the distribution of watermarked content. This component records details about each content piece distributed, including the unique hash, the associated salt, and distribution context, facilitating the tracking of content distribution and identifying potential leaks. The watermark detection and extraction tool identifies and extracts the embedded hash from the content for verification purposes. This tool is important for content authentication, integrity checks, and tracing the source of content in cases of unauthorized distribution. The verification database stores records of all generated hashes, salts, and associated content and user information. This secure database is important for verifying the authenticity and integrity of content and for investigating unauthorized distribution.

A particular, non-limiting example of an embodiment of a process flow for a system incorporating the foregoing components features the steps of content preparation, salt generation, hash generation, watermark embedding, content distribution and watermark verification. These types are described in greater detail below.

In the content preparation step, the content analysis module evaluates the content to identify the best approach for hashing and watermark embedding. In the salt generation step, for each content access or distribution request, the salt generator creates a unique salt based on predefined criteria. In the hash generation step, the hashing engine combines the content (or relevant segments of it) with the generated salt to produce a unique hash value. In the watermark embedding step, the watermark embedding tool integrates the hash into the content or its metadata, ensuring the watermark's imperceptibility and security. In the content distribution step, watermarked content is distributed to users, with the content distribution tracker logging the event and associated details. In the watermark verification step, when necessary, the watermark detection and extraction tool retrieves the embedded hash from the content, which is then compared against records in the verification database to authenticate the content, verify its integrity, and trace its distribution.

This content hashing with salt system disclosed herein offers a secure and effective method for watermarking digital content, enabling content integrity verification, origin authentication, and unauthorized distribution tracking while maintaining content usability and quality.

Various considerations may be taken into account in implementing these systems and methodologies. For example, the system should ensure the security of the hashing process and protect user and content information, adhering to privacy regulations. The chosen hashing algorithm should be strong enough to prevent collisions (different content producing the same hash) and resilient to attempts to reverse-engineer the hash. The system should be designed to handle large volumes of content efficiently, ensuring quick processing times for hashing, embedding, and verification processes. The system should also be adaptable to various content types and distribution platforms, accommodating different formats and usage scenarios.

### G. File Transformation

In other embodiments of the systems and methodologies disclosed herein, watermarking may occur through file transformation. In such embodiments, the file transformation preferably involves transforming a part of the file in a reversible manner based on the access details. For example, in a text document, certain words may be slightly altered or formatted differently (e.g., changing font size or color in an inconspicuous way) based on a predefined algorithm that uses the user's access information. The original content may be restored by reversing the transformation, which does not involve traditional encryption but still provides a level of security and traceability.

One particular, non-limiting embodiment of a system that may be utilized to implement the foregoing methodology includes a transformation engine, a watermark generator, a content analysis module, a reversal module, a verification and detection tool, a user and content database, and a distribution tracker. These components are described in greater detail below.

The transformation engine is the core component that applies predefined alterations to the digital content to embed the watermark. This engine is capable of performing slight, reversible changes to text, images, audio, and video files based on a set of transformation rules that encode the watermark.

The watermark generator creates a unique digital watermark for each piece of content, which could be based on user information, content ID, timestamp, and other relevant metadata. This watermark is then converted into a series of transformations by the Transformation Engine. The content analysis module analyzes the content to determine the most suitable areas for transformation that will least affect the content's integrity and perceptibility. For example, in images, it might identify less noticeable areas for pixel modification; in text documents, it could select spaces or punctuation marks for slight alterations. The reversal module is designed to reverse the transformations applied to the content, restoring it to its original state. This component is important for ensuring the watermarking process does not permanently alter or degrade the content's quality. The verification and detection tool extracts and decodes the watermark from transformed content. This tool is used to authenticate content, verify its integrity, and trace unauthorized distribution. The user and content database stores records of all watermarks, associated content, and user information. This database is important for managing the watermarking process and supporting the verification of content authenticity and ownership. The distribution tracker monitors the distribution of watermarked content, logging each instance of access and sharing. This component helps in tracking the spread of content and identifying potential leaks or unauthorized distributions.

A particular, non-limiting example of an embodiment of a process flow for a system incorporating the foregoing components features the steps of watermark creation, content preparation, transformation application, content distribution, watermark verification, and content restoration. These steps are described in greater detail below.

In the watermark creation step, for each piece of content, the watermark generator creates a unique watermark based on specific criteria relevant to the content and its intended distribution. In the content preparation step, the content analysis module evaluates the content to identify the most suitable regions or elements for applying transformations. In the transformation application step, the transformation engine applies the set of rules that correspond to the generated watermark, subtly altering the content in a way that embeds the watermark. These transformations are designed to be imperceptible or minimally invasive. In the content distribution step, once the watermark is embedded, the content is ready for distribution. The distribution tracker logs the event, including details about the content, recipient, and watermark. In the watermark verification step, if there is a need to verify the content's authenticity, integrity, or trace its distribution, the verification and detection tool extracts and decodes the watermark from the content, comparing it against the records in the user and content database. In the content restoration step, if necessary, the reversal module may be used to remove the watermark and restore the content to its original, unaltered state.

The foregoing file transformation-based watermarking system offers a flexible and secure method for embedding unique identifiers into digital content, enabling effective content tracking, authentication, and rights management while preserving content quality.

Various considerations may be taken into account in implementing these systems and methodologies. For example, the system should ensure that transformations do not perceptibly degrade the content's quality, maintaining its original usability and integrity. The transformations should be resilient to common content manipulations (e.g., compression, format conversion) to ensure the watermark remains detectable. The process of embedding and detecting watermarks should be efficient, minimizing the processing time required to handle large volumes of content. Moreover, measures should be in place to secure the watermarking process and protect sensitive information stored in the database, ensuring compliance with privacy laws and regulations.

### Tying Dynamic Watermarks to Blockchain Identities

In certain embodiments, a dynamic watermark may be associated with a blockchain identity such that each watermarked file or piece of content is bound to a verifiable on-chain credential, such as a wallet address or a decentralized identity (DID). In these implementations, once a user proves ownership of a blockchain address (for example, by signing a message with a corresponding cryptographic key), that address is incorporated into a watermark “blueprint” in real time. The watermark blueprint can also include the current block timestamp, additional contextual parameters (e.g., membership token details), or random seeds from a smart contract, thereby providing a unique, on-demand identifier for each instance of file access.

The blockchain identity becomes relevant because it confers the advantage of immutable, public verifiability. Even if users remain pseudonymous or anonymous, a wallet address or DID serves as an unambiguous identifier on the blockchain. Any content that later appears in an unauthorized context can be inspected to extract the embedded watermark and directly map the leak to the address in question. This on-chain link thereby allows for expedited and transparent community or organizational enforcement mechanisms, such as revoking privileges, denying future access, or other on-chain penalties.

In certain embodiments, the specific parameters used for watermark generation may include the user's wallet address, a current block number or timestamp, the user's mode of access (e.g., web interface, mobile application, command-line interface), or any relevant context (such as the token ID of an NFT the user holds). Incorporating these parameters into the watermark ensures each request results in a distinct and traceable version of the content. For instance, when the watermark references a particular token ID, it becomes possible to distinguish between different levels of membership or different tiers of subscription-based services, all while maintaining the user's pseudonymity.

Furthermore, tying dynamic watermarks to blockchain identities can be performed with minimal disclosure of personal data. The blockchain address or DID alone suffices to link the watermark to the user's on-chain activity, without requiring details about the user's real-world identity. In some implementations, the embedded watermark data may be encrypted, thereby ensuring that only authorized parties—such as the operator of a distributed autonomous organization (DAO)—can decrypt it to confirm the wallet address in question. Zero-knowledge proofs or similarly advanced cryptographic techniques may also be employed to provide additional privacy while preserving the ability to audit or enforce outcomes should leaked content be discovered.

In exemplary use cases, DAOs that require sharing confidential proposals may employ this approach by embedding each member's blockchain address into a watermarked document (e.g., a PDF). If this document surfaces outside of authorized channels, the DAO can immediately determine which on-chain address accessed or disseminated it. Similarly, NFT-based platforms that offer token-gated content (such as high-resolution digital art or limited-edition media) can embed watermarks that reference the holder's address, thereby deterring unauthorized copying or resale, as any leaked copy can be linked to the specific wallet responsible.

In some embodiments, a watermark system tied to blockchain identities may also include automated on-chain or off-chain enforcement. Once a leaked file is discovered, the embedded address (extracted from the watermark) may be flagged, and smart contract logic can automatically impose penalties. For instance, the contract might remove that address from a membership list, revoke its ability to mint new tokens, or prompt a governance vote to exclude the offender from certain DAO privileges. This design harnesses the immutability of blockchain records, making it exceedingly difficult for offenders to deny or obscure their involvement.

Various implementations may store or reference watermark-related data in both on-chain and off-chain environments. For example, the user's wallet address might be stored in the watermark itself, while certain keys or encrypted logs remain in a secure off-chain database. A hash of those off-chain logs may then be recorded on-chain to guarantee immutability and prevent tampering. Consequently, the system achieves a robust hybrid architecture that takes advantage of both decentralized identity and efficient off-chain storage.

Although a blockchain address inherently provides a high degree of transparency, it is still possible to incorporate user privacy controls. For example, the watermark may store only a hashed version of the address or a pointer to a zero-knowledge proof. If the watermark is subsequently discovered in a leaked file, authorized entities can decrypt or verify the proof to ascertain the wallet address, but no one else can trivially read the embedded data. Thus, while the watermark enforces accountability, it does so in a manner that can be balanced against user privacy concerns.

Certain implementations may leverage additional innovations to enhance the user experience. A dynamic watermarking engine could respond in real time to each request, fetching updated on-chain context (such as a user's reputation token or soulbound credential) and adding that data to the watermark. For instance, if a specific address holds a social reputation NFT, the watermark could include cryptographic proof of that credential. Over time, the system may adapt to changing membership statuses or other fluctuations in on-chain data, ensuring every newly accessed file or piece of content reflects the user's current blockchain-based context.

Lastly, future developments may employ zero-knowledge watermarking or cross-chain identity solutions to accommodate situations in which a user's identity spans multiple networks (e.g., Ethereum, Polygon, and other chains). In such embodiments, the watermark could unify addresses across chains, offering a consolidated trace if content were leaked. Regardless of specific parameters, the underlying principle remains that tying dynamic watermarks to blockchain identities leverages both the traceability of watermarking and the publicly verifiable, tamper-resistant nature of decentralized ledgers to provide a powerful and secure framework for distributing digital content.

### A. Tying Dynamic Watermarks to Blockchain Identities

In one illustrative embodiment, a distributed, computer-implemented system is provided for generating, embedding, and verifying digital watermarks tied to blockchain-based identities. The system can be implemented in a client-server architecture, with some components optionally running in a decentralized or cloud-based environment. At a high level, the system includes: (a) a Watermark Server that handles watermark generation and embedding, (b) one or more User Devices (e.g., personal computers or mobile phones) equipped with blockchain wallet software or decentralized identity (DID) modules, (c) a Blockchain Network (such as, for example, Ethereum, Polygon, or a private chain) that verifies user ownership of addresses or tokens, and (d) a Secure Database (or other persistent storage) that maintains logs and encryption keys required to correlate watermarks with access events.

### A1. Blockchain Identity Integration

A blockchain integration layer, referred to herein as the Blockchain Identity Module, comprises software routines that can query smart contracts, retrieve block timestamps, and validate user signatures. In some implementations, the Blockchain Identity Module is distributed between the user's local wallet software and remote components operating on the Watermark Server. For instance, the user's local wallet may sign a challenge to prove control of a particular address. The Watermark Server, upon receiving the signed challenge, invokes on-chain functions to confirm that the signature is valid for the claimed address, and optionally checks the user's token balances, NFT ownership, or DID credentials.

### A2. Dynamic Watermark Generation

Once the user's ownership of a specific on-chain credential is confirmed, the system proceeds to create a unique watermark for each access request. In one embodiment, a Watermark Generation Module on the Watermark Server includes cryptographic software (e.g., libraries such as OpenSSL, BouncyCastle, or similar) to assemble the following data into a watermark blueprint: (a) the user's blockchain address or DID, (b) the present block number or block timestamp from the blockchain, (c) any relevant NFT or token identifiers, (d) the type of content requested (e.g., PDF, image, audio file), and (e) an optional random nonce generated by a hardware security module (HSM). The Watermark Generation Module may convert these data into a binary code, hash digest, or encrypted token, which is then designated as the “dynamic watermark.”

### A3. Watermark Embedding

The generated dynamic watermark is passed to a Watermark Embedding Module, which includes software routines specifically designed to integrate invisible or minimally perceptible watermarks into different file formats. For image or video files, the embedding routines may rely on steganographic techniques such as discrete cosine transform (DCT) or least significant bit (LSB) manipulations. For documents (e.g., PDFs, DOCX files), the module may embed the watermark into metadata fields like “Author,” “Comments,” “Template Information,” or custom XML tags. For audio files, imperceptible frequency modulations or phase shifts may be employed. The Watermark Embedding Module is designed to output a newly generated, watermarked version of the content that the user is permitted to view, download, or otherwise access.

### A4. Real-Time or On-Demand Embedding

In certain embodiments, the Watermark Embedding Module operates in real time. Upon receiving a user request, the system may fetch a base version of the content from decentralized storage (such as IPFS, Arweave, or a cloud storage service). The Watermark Generation Module then dynamically computes the watermark for that user and request context, while the Embedding Module modifies the base version on-the-fly. The resulting file is then streamed or served back to the user, ensuring that each retrieval instance is uniquely and traceably watermarked.

### A5. Secure Logging and Key Management

Alongside content delivery, the system writes a record of the watermark parameters (e.g., the user's blockchain address, block timestamp, assigned nonce) to a Secure Database. In certain implementations, the database may reside off-chain but store cryptographically signed records or hashed references on-chain for immutability. If encryption keys are required for the watermarking process (for instance, if the watermark data is encrypted prior to embedding), those keys can be generated by an HSM and stored in an encrypted format within the Secure Database. An audit trail module may record the time of each content access event, the identity of the user, and the final watermark string for subsequent forensic analysis.

### A6. Leak Detection and Watermark Extraction

If a watermarked file later appears in an unauthorized context, the Watermark Extraction Module, which mirrors or reverses the techniques used by the Watermark Embedding Module, can be employed to retrieve the hidden watermark data. In the case of steganographic images or videos, specialized detection routines scan the media to recover the embedded bit patterns. For metadata-based watermarks in document files, the module reads specific fields or hidden XML tags. The extracted watermark is then matched against entries in the Secure Database to identify which blockchain address (or DID) was responsible for accessing that instance of the file. The system operator, such as the owner of the file or the administrator of a DAO, can then take action, for example, by revoking membership privileges, pursuing legal remedies, or publishing an on-chain alert.

### A7. Hardware and Software Resources

Various software and hardware resources may be leveraged for implementing the foregoing embodiment. Software resources suitable for implementing this embodiment include cryptographic libraries, such as OpenSSL, BouncyCastle, or other widely used libraries for hashing, key generation, and encryption of watermark data; blockchain integration frameworks, such as Web3 libraries (e.g., web3.js or ethers.js), to communicate with smart contracts, query on-chain balances, and verify user signatures; watermarking libraries and toolkits like OpenCV (for images and video), iText or Apache PDFBox (for PDF files), and FFmpeg (for media streams), which enable various forms of file manipulation; and databases, whether SQL-based (e.g., MySQL or PostgreSQL) or NoSQL-based (e.g., MongoDB), optionally supplemented by blockchain-based or IPFS-based storage components to preserve immutable logs. An application server (e.g., Java Spring, Node.js, or Python Flask) orchestrates watermark generation, embedding, and logging, while a hardware security module or secure key vault (e.g., AWS KMS, Google Cloud KMS, or dedicated hardware) facilitates tamper-resistant encryption key generation and storage. On the hardware side, the Watermark Server may reside on standard x86-64 machines, cloud-based virtual instances, or GPU-accelerated instances for real-time video processing, and large-scale implementations may incorporate load-balancing solutions and distributed caching to handle repeated requests for popular files efficiently.

### A8. Optional On-Chain Logging and Enforcement

In some implementations, each watermark generation event is also registered on-chain. That is, once a watermark is computed, the system posts a transaction to a dedicated smart contract to record a hashed representation of the watermark and the user's blockchain address. This approach guarantees a tamper-evident history of who accessed what content at which block height. Enforcement mechanisms may be built into a DAO governance contract that, upon presentation of evidence (i.e., the extracted watermark from a leaked file), can impose a penalty or remove the offending address from the DAO membership structure.

### A9. Advantages and Extensions

This embodiment provides enhanced security and accountability by associating every accessed file with an on-chain identity. It leverages off-chain cryptographic and steganographic processes to preserve file quality while ensuring that each retrieval is traceable. The system is readily adaptable to multiple file formats and may incorporate advanced techniques such as zero-knowledge proofs to protect user privacy until a leak investigation is triggered. In sum, tying dynamic watermarks to blockchain-based identities offers a powerful solution for mitigating unauthorized sharing of digital content, balancing user anonymity with strong deterrence and traceability.

### B. Watermarked NFTs and Token-Gated Content

NFTs (Non-Fungible Tokens) are widely used to provide holders with exclusive rights to digital media, whether high-resolution artwork, premium video content, limited-edition music, or confidential organizational resources. While the NFT itself can attest to ownership on a blockchain, restricting access to a download link or file storage platform does not inherently prevent unauthorized redistribution, as the underlying media file remains easily copied or shared once a user obtains it. A dynamic watermarking system designed for NFT-gated resources can mitigate this problem by associating each accessed file with a unique, cryptographically verifiable identifier corresponding to the holder's NFT and wallet address.

In an exemplary arrangement, a smart contract on a blockchain (such as Ethereum) maintains records of NFT ownership. A user who wishes to access premium content signs a message with the private key controlling the relevant NFT. The platform then verifies that signature on-chain to ensure the user truly holds the rights. Having confirmed ownership, the system generates a customized watermark for the user's requested file. This watermark embeds critical data: the user's NFT contract address, wallet address, timestamp, and any additional contextual information such as device IDs or random nonces. A hardware security module (HSM) or a cloud-based key management service may be used to protect the cryptographic keys used in creating or encrypting the watermark.

To integrate the watermark, specialized libraries can be used, such as OpenCV for image manipulation, FFmpeg for audio or video, and iText or Apache PDFBox for PDFs. These libraries apply a steganographic or metadata-based method that leaves the file's visual or auditory quality intact. Once embedded, the watermarked file is returned to the user, and details of the watermark (such as hashes, timestamps, and any applied cryptographic keys) are stored in a secure database. This process can run on standard server hardware, cloud-based virtual instances, or GPU-powered platforms if computationally intensive tasks such as high-resolution video watermarking or large-scale concurrency are anticipated.

If the user's copy later surfaces in an unauthorized forum, external marketplace, or file-sharing network, investigators can retrieve that suspected file and run an extraction process to reveal the hidden watermark. The embedded identifier resolves to a record in the secure database or an on-chain reference, pinpointing the exact NFT holder responsible. In some implementations, the system can automatically execute remedial measures through a smart contract to revoke or restrict that user's future access, publicly flag their address, or update membership privileges.

Because the system can select among various watermarking approaches depending on file type or distribution channel, it remains suitable for a wide range of digital assets, from static images to streaming video. It thereby provides far greater deterrence to unauthorized distribution than a simple token gate, making each copy traceable back to a unique on-chain address. As a result, creators, decentralized organizations, or NFT-backed communities can not only limit access to content but also preserve robust evidence for enforcement actions if that content is misused.

Integrating with Smart Contracts for Automated Enforcement

A secure database or log within the system typically records sensitive data such as encryption keys, user access parameters, and unique watermark identifiers. In a web3 environment, this architecture can be enhanced by placing critical fingerprint metadata and associated events on a blockchain, while detailed records remain off-chain in a secure database. Doing so preserves the scalability and adaptability of off-chain storage while leveraging the immutable, publicly verifiable nature of a blockchain ledger. A hashed reference to each watermark event may be recorded in a smart contract, ensuring that any subsequent attempt to alter or remove the record would be detected. When a forensic check is later run against a leaked file, the watermark can be matched to its on-chain reference, which correlates to the user or address responsible for the original access session. Because the blockchain stores only a minimal hashed record, sensitive keys or detailed session data remain protected in the private database, yet there is still a transparent link between the user's on-chain credential and the context-specific watermark.

By weaving these on-chain references into the patent's dynamic watermarking system, automated enforcement steps can be taken whenever an unauthorized copy is detected. A smart contract can, for instance, revoke future access tokens for that user's address, restrict DAO privileges, or even levy an on-chain penalty once the watermark confirms who leaked the file. Additionally, real-time parameters such as block timestamps or blockchain-based random seeds can be passed into the watermark generation process. Even if the same user initiates multiple requests in rapid succession, each watermark will differ cryptographically, and any discovered duplicates remain traceable to a single event on the chain.

In an exemplary implementation, a smart contract is deployed on a blockchain network such as Ethereum or Polygon to define methods for logging watermark events and enforcing user privileges based on a token or DAO membership. A conventional web server, implemented in Node.js or Python Flask and equipped with blockchain libraries, handles off-chain orchestration by validating user credentials, retrieving random seeds or timestamps from the contract, and combining those parameters with user-specific factors such as device ID or session token to produce a unique encryption key. This key is then used to embed the watermark into the file, often via libraries such as OpenCV, FFmpeg, or Apache PDFBox, depending on whether the file is an image, video, or document. The server posts a hashed record of the watermark event (containing core session identifiers and cryptographic hashes) to the smart contract, thereby making the transaction publicly verifiable. Meanwhile, the full watermark details, encryption keys, and usage logs remain in a secured off-chain database such as PostgreSQL or MongoDB, optionally protected by hardware security modules or cloud-based key management services. If the watermarked file later appears on an unauthorized platform, a watermark extraction utility can decode the file's embedded fingerprint, match it to the on-chain log, and trigger automated or manual enforcement steps, such as revoking that user's on-chain privileges or flagging the address for DAO review.

### Protecting Decentralized Autonomous Organization (DAO) Documents

DAOs often deal with sensitive organizational information—such as strategic proposals, product roadmaps, or detailed financial statements—that must be shared exclusively among authorized members. A dynamic, context-aware watermarking system ensures that each DAO member who accesses or downloads a document receives a uniquely watermarked copy. By leveraging a membership token ID or equivalent on-chain credential, each request to view or retrieve a confidential PDF, slide deck, or spreadsheet generates a custom watermark encoding the member's address, the time of access, and the method of retrieval. Because members often participate pseudonymously, the on-chain token remains cryptographically tied to the distributed file without requiring them to reveal any real-world personal data. If a document containing privileged information emerges on an unauthorized platform, the watermark reveals which token was used to obtain it, allowing prompt detection of the leak.

In a representative implementation, a DAO deploys a “Membership Token” smart contract on a blockchain such as Ethereum or Polygon, which grants holders of a specific ERC-721 or ERC-1155 token the right to access confidential documents. A backend service, built with Node.js or Python Flask, queries this contract to confirm that a user's address still holds a valid membership token before permitting a download of, for instance, a PDF or spreadsheet. This verification step typically uses blockchain libraries (e.g., ethers.js, web3.py) to check token balances in real time. Once authenticated, the backend fetches the requested file from a storage service such as AWS S3, IPFS, or a private repository. A “Dynamic Watermark Module” then creates a unique watermark blueprint, typically reflecting the member's token ID or wallet address, a timestamp or block number signifying time of access, and the user's access method. By incorporating these parameters into an encryption key or embedded metadata, the system ensures that each user receives a uniquely identifiable copy. Toolkits like iText, Apache PDFBox, or specialized Office APIs facilitate both visible and hidden embedding strategies, enabling subtle text or pixel changes that remain imperceptible to users.

For time-based revocation or similar constraints, the watermark blueprint can incorporate a short-lived cryptographic nonce from a sidechain or the DAO's contract. After a predefined block number or timestamp, that nonce becomes invalid, thereby preventing re-downloads or indicating membership expiry. An off-chain database such as PostgreSQL or MongoDB records references to each watermark event, logging user addresses, watermark parameters, and cryptographic hashes of the relevant keys. These keys may be secured by a hardware security module (HSM) or cloud-based key management service to safeguard their confidentiality. Each new download session produces a fresh watermark incorporating the latest access time, guaranteeing full traceability across multiple requests for the same file.

Should a confidential file circulate outside the DAO's intended distribution channels, the DAO's security team or an automated script can download the unauthorized copy, reverse the watermarking process with a forensic extraction tool, and reveal its embedded token ID or membership address. The system then checks the off-chain logs to determine which user obtained the file. Because that watermark is cryptographically linked to the user's on-chain membership ID, the DAO can impose enforcement actions directly-perhaps by transferring the membership token to a locked address, removing the holder's future access, or soliciting a DAO-wide vote to consider additional penalties. The technical architecture generally runs on x86-64 servers or cloud instances, with GPU-accelerated machines or a load-balanced cluster if large-scale concurrency or video watermarking is anticipated. Caching layers (e.g., Redis) may be employed to handle repeated downloads of popular DAO documents quickly. This design maintains strong anonymity for members while providing a reliable mechanism for tracing data leaks back to cryptographically verifiable token holders.

### Enabling Royalty Tracking and Secondary Market Oversight

Many NFT projects depend on royalties as a continuing revenue stream, yet enforcement can be difficult if secondary marketplaces or resale platforms fail to honor those obligations. A watermarking system aligned with the patented techniques can supplement or reinforce the typical smart contract-based royalty logic. In particular, when users request a high-definition asset tied to an NFT, the watermarking process can embed both the user's identity or session details and the original creator's ID or royalty policy reference. Even if that user later attempts to bypass royalties by listing the content on a non-compliant platform, a forensic check of the file's watermark will confirm who accessed it, as well as the rightful royalty beneficiary. This combination of user-specific and creator-specific watermark data provides a reliable basis for social, contractual, or legal enforcement: the file itself carries a cryptographic link to the original NFT minter or royalty rules.

In one representative implementation, the NFT resides on a blockchain such as Ethereum or Polygon. Its core metadata references an off-chain asset—commonly stored on AWS S3, IPFS, or Arweave—rather than embedding large files directly on-chain. A Watermark Server (for example, a Node.js or Python Flask application) mediates access to that asset. Whenever a token holder requests the original media, the system checks the wallet signature or token balance using blockchain libraries (ethers.js, web3.py, or similar), retrieving any relevant royalty policy details from a dedicated smart contract. The server then creates a watermark blueprint containing the user's wallet address, a unique timestamp or session token, and the creator's ID or royalty reference. A library such as OpenCV (for images), FFmpeg (for video), or PDFBox (for documents) hides this watermark in a steganographic or metadata-based manner—possibly encrypting or hashing it with a key protected by a hardware security module (HSM) or cloud-based key management service (KMS).

The system also logs each watermark creation event in an off-chain database, linking the NFT's ID, the user's address, and the newly embedded watermark. Thus, if the user lists the file on a rogue marketplace that ignores royalties, an investigator can extract the watermark via a Forensic Extraction Tool (using the same libraries but in reverse), revealing the embedded references. Such evidence helps creators confirm that the NFT's content was distributed without compliance, potentially deterring or penalizing the offending seller. Moreover, the patent's “behavioral watermarking” can detect suspicious, automated usage patterns by capturing and hashing data such as keystroke timing or repetitive request intervals into the watermark blueprint. If a large swath of minted or distributed NFTs exhibit identical behaviors, the system may flag them as bot-driven, prompting added on-chain restrictions or blacklisting. The technical architecture typically executes on x86-64 servers or virtual instances, with optional GPU acceleration if high-volume or large-scale media processing is involved. The Forensic Extraction Tool can be delivered as a command-line interface, an integrated web module, or a standalone desktop application, enabling authorized stakeholders to verify watermarks and confirm rightful royalty claims or detect policy violations.

### Distributed Storage (IPFS, Filecoin, Arweave) Plus Dynamic Watermarks

In a decentralized web3 context, large media files are frequently stored on IPFS, Filecoin, or Arweave so they can be globally replicated among multiple nodes. This ensures immutability and resilience, yet it also poses challenges for content owners who need personalized or traceable file distribution. A simple upload to IPFS typically yields a single static file (identified by a unique CID), which users can all download in identical form. If an owner wants to prevent unauthorized redistribution or identify leaks, this static approach offers little control or traceability, since no user-specific data can be baked into the file after it has been pinned to the network.

One way to address this challenge is to keep the decentralized storage layer strictly for storing an encrypted or incomplete version of the file while relying on an access gateway to merge, decrypt, or finalize the file at request time, inserting any necessary watermarking data in the process. In other words, although the IPFS copy remains immutable, the user never receives that raw version directly. Instead, a dynamic server-side mechanism modifies or decrypts each file on the fly, generating a unique watermark—based on the user's identity, session tokens, or blockchain parameters—and embedding it into the final deliverable. This arrangement effectively extends the notion of “mutable references to immutable content” by layering a personalization step onto the request pathway.

A representative implementation begins with the content owner encrypting a large media file using a one-time key before uploading it to IPFS in multiple segments. A manifest file may describe these chunks, providing a map of how they combine to form the original media. Both the chunks and the manifest can be pinned across the IPFS network, ensuring that no matter how many nodes mirror the data, it remains consistent and unmodified. The decryption key—or partial fragments of it—stays securely off-chain, often under the control of a hardware security module (HSM) or a cloud-based key management service (KMS). Whenever a user with the necessary on-chain credentials (e.g., an NFT or membership token) attempts to download the file, the access gateway verifies that credential using a blockchain library such as ethers.js or web3.py. If validated, the gateway fetches the encrypted chunks from IPFS, reconstructs them locally, and decrypts them only as part of a process that also embeds a user-specific watermark.

To produce that user-specific watermark, the gateway calls upon the dynamic logic described in the patent: for instance, generating a watermark blueprint derived from the user's wallet address, the current block timestamp, and device attributes. Libraries like OpenCV, FFmpeg, or Apache PDFBox may be used to insert this watermark steganographically into the image, audio, video, or document data. As each chunk is decrypted, the gateway modifies it according to the newly derived watermark data, then assembles the modified chunks into a single coherent file or stream. The user subsequently receives a personalized version that is visually or functionally identical to the original but contains nearly invisible markers linking it to their on-chain address or session.

Throughout this procedure, a logging mechanism records the watermark event—storing a hash of the watermark blueprint, the user address, and the relevant block timestamp—into a secure off-chain database or partially on-chain for immutability. If a leaked file appears in an unauthorized forum, investigators can run a forensic extraction tool to read the embedded watermark, compare it with the gateway's logs, and unambiguously identify which user accessed that copy. Although the file pinned to IPFS never changes, each user's instance emerges from a gateway-driven customization step, thus restoring some measure of control and traceability to an inherently immutable storage environment.

### Distributed Storage (IPFS, Filecoin, Arweave) Plus Dynamic Watermarks

In many web3 environments, large media files are stored on decentralized networks such as IPFS, Filecoin, or Arweave, which guarantees resilience and immutability but does not easily allow user-specific modifications. Once a file is pinned or replicated, it becomes fixed at a unique content identifier (CID). To introduce personalization and traceability, a system can embed dynamic watermarks at the moment of retrieval, rather than uploading a static, fully decrypted file. The content owner encrypts or partially encrypts the asset prior to upload, splitting it into multiple chunks. A manifest file—also pinned—describes the format and layout. Neither the complete decryption key nor any user-related watermark parameters reside on the decentralized network.

When a user with appropriate credentials requests this asset, an off-chain access gateway (for instance, a Node.js or Python Flask service) verifies on-chain ownership, using a blockchain library to check the user's NFT balance or membership token. Upon validation, the gateway fetches the relevant chunks from IPFS, then consults a secure key store such as a hardware security module (HSM) or a cloud-based key management service (KMS) to retrieve the partial decryption keys needed to assemble the file. At this point, the system generates a user-specific watermark blueprint, combining data such as the user's wallet address, a random seed, or session context. A steganographic or metadata-based technique—handled by libraries like OpenCV, FFmpeg, iText, or PDFBox—integrates the watermark into the file as it is decrypted or merged. Because all final assembly occurs off-chain and under the content owner's control, the decentralized copy remains immutable, yet each user ends up with a uniquely identifiable version.

This architecture preserves the “immutable” nature of the pinned file while introducing a crucial personalization layer. A record of each retrieval event, including the user's address and a hashed reference to the watermark blueprint, may be stored in a secure off-chain database or optionally logged on-chain for tamper-evident reference. If a leaked copy is found in an unauthorized forum, a forensic extraction tool (employing the same library that performed the embedding) can parse the watermark, revealing which user session produced it. From a hardware standpoint, the gateway typically operates on standard x86-64 or ARM servers, with optional GPU acceleration if large files or streaming segments require real-time processing. Key management through an HSM or a cloud KMS ensures that file encryption keys remain protected, preventing adversaries from bypassing the watermarking step. Thus, creators can confidently host their media in a truly decentralized manner while still tailoring each distributed copy for traceability and deterrence against unauthorized sharing.

As will be appreciated from the foregoing, some embodiments of the systems and methodologies disclosed herein involve their implementation in a web3 setting. In many web3 scenarios, NFTs, membership tokens, or similar on-chain credentials allow users to access or download unique digital assets, yet the decentralized nature of blockchain-based networks can make it difficult to trace individual copies once they spread. A dynamic watermarking system seamlessly addresses this challenge by incorporating wallet-specific or session-specific data into each distributed file. Because the watermark data references a blockchain address (either directly or via hashed identifiers), it allows file owners or investigators to pinpoint exactly which user initiated a particular download—even if the user operates behind multiple relays, zero-knowledge proof mechanisms, or pseudonymous blockchain profiles. This level of fine-grained traceability is especially vital in communities where quick proliferation of content is the norm, as it ensures creators retain the ability to forensically track leaks without requiring invasive IP-based monitoring.

Furthermore, the knowledge that each download is explicitly tied to a unique, nearly invisible watermark exerts a substantial deterrent effect on malicious actors. Users understand that any unauthorized redistribution or resale of their copy can be linked back to their on-chain credentials, undermining claims of plausible deniability. This deterrence has a natural fit in web3 ecosystems, where the emphasis on pseudonymity can make it otherwise challenging to hold people accountable for content misuse. The dynamic watermark imbues each user's copy with an inbuilt “fingerprint,” reinforcing the notion that they remain responsible for how it is subsequently shared.

Notably, the system's architecture can be designed so that only hashed or encrypted versions of a user's credentials are embedded, meaning personal information remains private. Off-chain computation of the watermark, or partial off-chain key management, circumvents the need to publicly disclose wallet addresses or session data on-chain, which would compromise user anonymity. Instead, the chain might store a minimal record (such as a cryptographic hash or event log referencing the watermark) while the actual user data (or partial keys) resides in a secure database or hardware security module. This approach preserves user privacy while retaining the transparency and accountability benefits of blockchain technology.

Finally, each instance of watermark creation or file distribution can be logged on-chain, or accompanied by a cryptographic proof that is then committed to a publicly readable ledger. Members of the community, auditors, or even automated scripts can verify the existence of a particular watermark event by checking the corresponding transaction or hash reference. This “blockchain auditability” provides both an immutable log of access events and a decentralized trust model: the network collectively attests to when and by whom a file was requested, thereby dispelling doubts about tampering or backdating of logs. Put together, these capabilities afford web3 projects a powerful and adaptable framework for distributing content in a manner that is traceable, privacy-conscious, and rigorously auditable by the broader community.

In a typical application, when a user attempts to access an exclusive piece of digital content in a web3 context, they typically initiate the process by connecting their blockchain wallet, for instance via MetaMask or WalletConnect, to authenticate ownership of a relevant NFT or membership token. Behind the scenes, a smart contract or an off-chain verification service confirms that the user's wallet address holds the necessary token or has the proper permissions to request the content. This establishes the user's eligibility in a trustless manner, leveraging verifiable on-chain data rather than relying on a conventional username/password system.

Once the user's eligibility is confirmed, the system dynamically generates a watermark. It compiles contextual parameters that can include the user's wallet address, a timestamp or block number, and possibly additional data points like device identifiers, user behavioral metrics, or the time of day. Some implementations might further randomize the watermark by integrating a block-based random seed or pulling a verifiable random value from a specialized contract. Because this blueprint is freshly computed for each access request, no two downloads yield an identical watermark.

Using libraries appropriate to the file type (OpenCV or FFmpeg for images and videos, or iText/PDFBox for PDFs) the system steganographically (or otherwise imperceptibly) embeds this unique watermark into the underlying media. This ensures that to the naked eye, the file remains identical to the original asset. However, under a forensic examination, one can decode or detect the watermark bits, revealing a record of which user (i.e., which blockchain address or NFT ID) acquired that particular copy.

After watermark insertion, the system serves the newly watermarked file to the user—via direct download, streaming, or another distribution mechanism—and records the details of the transaction. This log entry might include a hash of the watermark blueprint, the user's address, the block timestamp, and any additional session data. Depending on the privacy or compliance requirements, these records can be fully or partially stored in an off-chain secure database or hashed onto the blockchain for immutable referencing.

Should an unauthorized copy of this watermarked file emerge, investigators or community members can run a watermark extraction tool. By comparing the extracted watermark data to the reference logs, one can establish precisely which user session produced that file. Armed with this proof, the content owner or a DAO governance mechanism can implement appropriate enforcement measures on-chain—such as revoking future access from the offending address, imposing a token-based penalty, or publicly identifying the violator's address. This blend of decentralized credential verification, dynamic watermarking, and immutable logging thus delivers strong leak deterrence and robust forensic capabilities within a web3 ecosystem.

Various end uses are possible with the systems and methodologies disclosed herein. The following are some particular, nonlimiting examples.

### Example 3

In a corporate data security scenario, a corporation implements a system of the type described herein to protect sensitive documents such as financial reports, proprietary research, and strategic plans. The system 201 comprises several interconnected components that ensure enhanced security and traceability. These include a Receiver component 203, a Processor 205, an Embedding Module 207, a Distribution Module 209, a Secure Database 211, and a Decryption and Analysis Unit 213.

The Receiver component 203 accepts and logs access requests 221 for a data file 223 when an employee or authorized user requests access. The Processor 205 dynamically generates an encryption key 231 based on specific parameters 233 of the access request, including the user's identity 235, the time of access 237, and the mode of access 239 (e.g., via a secure network, remotely, or from a mobile device). The Embedding Module 207 then uses this encryption key to insert a unique digital watermark 241 into the data file. Once watermarked, the Distribution Module 209 provides the watermarked file 251 to the requester, with the distribution details 253 logged for accountability.

A Secure Database 211 stores information about the generated encryption keys and associated access parameters, serving as an audit trail for all document accesses. In the event of an unauthorized distribution or leakage, the Decryption and Analysis Unit 213 decrypts and examines the digital watermark to determine the source of access 271 or leakage 273, identifying the specific instance that led to a compromise. This system enhances document security within the corporation, ensuring that all file accesses and distributions are logged and traceable to individual users under specific conditions. This traceability not only aids in rapid forensic analysis in the event of a breach but also acts as a deterrent against unauthorized access and sharing, as employees are aware that any unauthorized distribution can be traced directly back to them.

### Example 4

A system of the type described herein is implemented to leverage blockchain technology for dynamic watermarking of digital files in a scenario involving digital artwork distribution on a blockchain platform. The system ensures the traceability and accountability of digital content distribution. The system 301 in this example includes a Server Computer with Watermark Generation Module 303, a Blockchain Network Validation 305, a Dynamic Watermark Composition 307, a Watermark Embedding Module 309, a Distribution Module 311, a Secure Database 313, and a Watermark Extraction Module 315.

The Server Computer with Watermark Generation Module 303 initiates the process when a user attempts to download a digital file. This module receives the user's request 321 and obtains a cryptographic challenge 323 from the user's blockchain wallet 325 or a Decentralized Identity (DID) 327, verifying that the user indeed controls a specific blockchain address or DID. After validation through Blockchain Network Validation 305, which references the on-chain records 331 to confirm ownership of necessary tokens 333 or NFTs 335, the Server Computer's Watermark Generation Module 307 composes a dynamic watermark 343 that incorporates the user's verified blockchain identity 345, a timestamp 347, and any relevant NFT or token 349 identifiers.

Once the dynamic watermark is created, the Watermark Embedding Module 309 takes over, embedding the watermark into the requested file 351 in a manner that is imperceptible under normal viewing or playback. The Distribution Module 311 subsequently provides the watermarked file 361 to the user, ensuring that a record 363 of this event is captured. During this process, a Secure Database 313 stores detailed records 371 of the watermark generation, including correlations 373 between the user's blockchain identity 375 and the specific watermark parameters 377. If the watermarked file later appears in an unauthorized context, the Watermark Extraction Module 315 can retrieve the embedded watermark 381, compare it to the records 371 in the Secure Database 313, and determine which blockchain address or DID 327 was associated with that file's initial download. This holistic system ensures accountability for file distribution, leveraging blockchain technology to provide an immutable link between each downloaded file and the identity of the user who accessed it.

### Example 5

A popular digital art platform adopts a system of the type disclosed herein to secure its premium artwork and automatically enforce consequences for users who leak or redistribute files without authorization. The system 401 includes a User Interface or API Layer 403, a Blockchain Integration Module 405, a Watermark Generation Engine 407, a Watermark Embedding Module 409, a Secure Off-Chain Data Store 411, a Smart Contract and On-Chain Logging 413, and a Watermark Extraction Tool 415.

In the token-gated digital art distribution scenario, a user begins by requesting access to a premium artwork through the user interface or API layer 403, where they must sign a cryptographic challenge 421 with their blockchain wallet 423. The system's blockchain integration module 405 immediately queries a smart contract 431 on a public blockchain 433 (for example, Ethereum or Polygon) to verify that this user's address holds the necessary token or membership credential 435 to view and download the artwork. Only when the user's on-chain ownership is confirmed can the request proceed.

Once validated, the system calls upon the watermark generation engine 407, which derives a unique watermark key 441 for this specific access event by combining blockchain-derived parameters 443 (such as the current block number or token ID) with user-specific factors 445 (like the user's wallet address and timestamp). The newly created key 441 then passes to the watermark embedding module 409, which integrates the watermark 441 imperceptibly into the digital painting (either through slight modifications in the metadata or minimal pixel shifts that do not diminish the art's visual fidelity).

Every watermarking event is recorded in a secure off-chain data store 411, capturing details such as the user's blockchain address 461, the precise watermark key parameters 463, and a cryptographic hash of the watermark blueprint 465. To further enhance transparency and tamper resistance, the platform also submits this hashed record to a smart contract on the blockchain 413, creating an immutable, verifiable log of which user accessed the file at a particular time and under what conditions.

Should the watermarked artwork appear in an unauthorized context, the system's watermark extraction tool 415 analyzes the discovered copy 471. By retrieving the embedded watermark, it can match the watermark key to the original event data in the off-chain data store 411 and on-chain log. This functionality allows the platform to confirm exactly which address obtained that specific file and then initiate automated enforcement actions such as revoking future access or penalizing the user through the smart contract, pursuant to the system described herein.

Artificial intelligence (AI) can enhance many parts of the disclosed dynamic watermarking systems and methodologies by making the underlying processes more adaptive, more secure, and better suited to large-scale or rapidly evolving usage scenarios. Below are several nonlimiting ways that AI can be advantageously applied.

### Risk-Based Watermarking Decisions

Risk-based watermarking leverages artificial intelligence to dynamically tailor the security and complexity of watermarks based on real-time context. An AI-driven risk engine continuously evaluates factors such as the user's geographical location, the time of day, and any known patterns of suspicious behavior. If, for example, a user normally accesses files only through a corporate VPN during business hours, but suddenly logs in from a remote region in the middle of the night, the system can interpret these conditions as a heightened threat context. In response, it may embed deeper steganographic watermarks, multiple overlapping markers, or additional encryption layers into the requested content, ensuring that any subsequent unauthorized copying can be definitively traced back to that anomalous access event.

Moreover, predictive analytics can help the system learn population-wide usage norms, including when and how content is typically consumed. By monitoring aggregate behavioral metrics (such as, for example, peak download times, common file types accessed, or average session duration), the AI models can forecast which sessions are likeliest to pose a leak risk. The watermarking module can then allocate extra computational resources to these higher-risk downloads, inserting more intricate or resilient watermarks that are harder to remove or obscure. This proactive allocation ensures that the most vulnerable or unorthodox sessions receive the most stringent watermark protections, effectively aligning the level of watermark defense with the real-time likelihood of unauthorized distribution.

### Improved Steganography and Watermark Robustness

Improved steganography and watermark robustness can be achieved by integrating artificial intelligence models that intelligently place watermark information within the content's data structure. In particular, neural networks (especially those trained on image or video domains) can identify “high-entropy” regions in the media where changes are difficult to visually or audibly discern. Such regions might include complex textures or transitional frames in a video stream. By embedding watermark bits in these high-entropy sections, the system better conceals them from both automated detection tools and human inspectors. Furthermore, because the AI model learns the subtle statistical patterns that define non-uniform areas, it can maintain the watermark's imperceptibility even if the file undergoes mild cropping, color shifting, or transcoding.

A complementary approach, known as adversarial training, refines how the watermark is embedded by subjecting it to simulated attacks prior to final placement. Machine learning pipelines can generate thousands or millions of artificially modified copies of the watermarked content, each incorporating a typical or advanced form of manipulation—for example, re-encoding at lower bit rates, injecting random noise, or partially corrupting segments. By observing which versions preserve the watermark successfully, the system gradually adapts its embedding strategy to maximize persistence under a variety of real-world conditions. This iterative adversarial methodology ensures that each new generation of watermarking parameters remains effective against evolving attempts to remove or obscure the watermark.

Implementation of these AI-driven steganographic improvements often involves specialized libraries for image and video processing, such as OpenCV or FFmpeg, integrated with neural network frameworks like TensorFlow or PyTorch. During the watermarking process, GPU acceleration can speed up both the scanning of high-entropy regions and the adversarial training loop, especially if large media files or extended sequences are being processed in bulk. A stable dataset of content samples—including varied resolutions, formats, and compression settings—allows the neural networks to generalize well to new media encountered in production. On the infrastructure side, a container orchestration system may be used to distribute model training across multiple nodes, ensuring the watermark embedding logic remains responsive under high user load.

In terms of security, the AI-based system can run within a secure enclave or rely on hardware security modules (HSMs) to protect cryptographic keys used in watermark encryption. While the neural model itself may not be highly secret, the embedded watermark keys certainly require protection against reverse engineering or malicious tampering. Coupled with the dynamic watermarking logic described elsewhere, these AI-enhanced steganographic routines provide a robust foundation that adapts to common attacks and helps the watermark remain intact and detectable over the file's lifecycle, thereby maintaining a powerful deterrent against unauthorized copying and distribution.

### Automated Leak Detection and Forensic Analysis

Automated leak detection and forensic analysis can greatly benefit from AI-based scanning systems. By deploying machine learning models trained to recognize specific images, video frames, or audio fingerprints, these scanning utilities can comb through external websites, file-sharing networks, and decentralized storage nodes (e.g., IPFS) to discover copies of media that match, or partially match, known watermarked content. When the system locates a probable match, an AI pipeline retrieves the file and attempts to detect and extract the embedded watermark. Once the watermark bits are recovered, the process checks a secure database to correlate the fingerprint with a particular user session or on-chain address, thereby providing conclusive evidence of the file's unauthorized distribution. This automation enables high-speed, large-scale enforcement efforts that would be infeasible using manual monitoring methods.

Furthermore, advanced AI clustering techniques can support investigators whenever multiple leaks are detected. By running unsupervised algorithms on a pool of recovered watermarked copies, the system can group those that share suspicious similarities such as consistent re-encoding artifacts, the same distribution points, or repeated references to specific user metadata. This pattern-based clustering helps administrators or DAO governance bodies see if a single user address, or a small coalition of users, is responsible for propagating leaked copies. Early detection of such patterns allows targeted interventions, including on-chain penalties, membership revocations, or legal responses.

Implementing these AI-driven leak detection measures typically involves additional software and hardware components. The scanning pipeline may rely on distributed crawlers and specialized image, audio, or video fingerprinting libraries—such as OpenCV for images, Librosa for audio, or bespoke neural network models—to index files across various platforms. A container orchestration solution, such as Kubernetes, can distribute crawler workloads for scalability and fault tolerance. Once potential matches are located, GPU-accelerated inference servers can handle watermark extraction, especially if steganographic detection routines involve complex signal processing. In larger deployments, this entire process may tap into a message queue or event-driven architecture to manage the flow of newly discovered files, ensuring the system remains responsive even under heavy scanning loads.

The forensic correlation step often uses a secure database, for example running on PostgreSQL, MongoDB, or a blockchain-based storage solution, where it retrieves the watermark blueprint records. Depending on the operational requirements, additional cryptographic infrastructure (e.g., HSMs or KMS solutions) may encrypt the watermark keys or reference logs to maintain confidentiality. AI-based clustering modules—potentially leveraging Python libraries like scikit-learn or specialized deep-learning frameworks—then link together suspicious leaks, highlighting repeated occurrences of the same user's watermark signature across different hosting platforms. This integrated approach offers an end-to-end solution that automates leak detection, pinpoints the responsible address, and empowers proactive or punitive actions to stem further unauthorized dissemination.

### Adaptive Key Management and Anomaly Response

Adaptive key management and anomaly response solutions allow a dynamic watermarking system to react swiftly to evolving security threats. By integrating machine learning models that predict usage spikes or detect shifts in typical user behavior, the system can rotate encryption keys or update watermarking parameters before potential vulnerabilities are exploited. If an AI model forecasts, for instance, that multiple users are scheduled to download high-value content around the same timeframe—perhaps based on historical traffic patterns or blockchain activity spikes—new keys or watermark schemas can be introduced in advance. This proactive approach reduces the risk that an adversary gains control of a key and distributes multiple copies of the same unaltered watermark. Instead, each segment of high-traffic usage receives updated cryptographic elements, limiting how many copies can be linked to any single compromised key.

Another critical aspect involves real-time anomaly triggers, which rely on continuous AI-driven monitoring of user sessions. When the system identifies a suspicious departure from normal patterns—such as a sudden cluster of requests from multiple, seemingly unrelated addresses or an unusually high frequency of downloads for one address—the AI module can escalate enforcement measures. In some cases, this might mean halting new downloads outright, requiring the user to re-verify their identity with multi-factor authentication, or shifting to a higher watermark complexity that is more tamper-resistant. By adjusting security on the fly, the system can thwart sophisticated, bot-driven attempts to mass-exfiltrate content before substantial leakage occurs, thereby reinforcing both trust and accountability.

In practice, implementing these AI-based adaptive solutions often involves connecting the watermarking engine to a streaming data infrastructure that captures live metrics about access events, user sessions, and file downloads. A queue or event bus framework (e.g., Apache Kafka) can feed these logs into a specialized ML inference service, potentially using a containerized environment like Docker or Kubernetes for elasticity. The models themselves may rely on time-series analysis or stateful neural networks capable of recognizing short- or long-term anomalies in user behavior. For performance and reliability, GPU-accelerated instances or TPU-based deployments can ensure quick model inference under high concurrency.

To handle cryptographic updates seamlessly, a hardware security module (HSM) or cloud key management service (KMS) can generate and store new keys. The watermarking server regularly requests updated encryption keys from this secure vault if the ML model predicts a heightened risk environment. Administrators may also configure explicit policy rules—such as maximum key lifetime or forced rotation intervals—to complement the AI-based triggers. Meanwhile, the system logs each key rotation event, preserving an audit trail of why and when each new cryptographic parameter was introduced. Combined, these elements yield a proactive, intelligence-driven security posture that adapts to emerging threats, providing strong deterrence and rapid containment if unauthorized file distribution attempts arise.

### Behavioral Watermarking Extensions

Behavioral watermarking can be greatly enhanced by leveraging advanced AI models that capture subtle, often overlooked signals in user interactions. While the patent's baseline approach may rely on keyboard or mouse usage patterns, deeper user modeling can incorporate micro-latencies—such as the pause times between specific clicks or the rhythm of scrolling—and broader application usage profiles (e.g., how quickly a user typically navigates between tabs or modules). Over time, a system trained on these richer data points constructs a refined “behavioral fingerprint” for each user. This fingerprint can then be embedded in a file's watermark at the moment of access, which dramatically reduces the chance that a malicious party can impersonate or replicate that user's unique operational style. Even if attackers gain legitimate credentials, their interaction patterns are likely to deviate from the expected baseline, helping the watermarking system detect anomalies or inject extra traceability measures into the distributed file.

Moreover, these more complex behavioral insights can seamlessly integrate with existing fraud detection pipelines. Many organizations already use machine learning to spot irregularities in user logins or payment activities, such as an unexpected foreign IP address or a new device signature. Tying these alerts into the watermark generation flow ensures that any suspicious session—one that triggers a high score in the fraud detection system—automatically receives a higher-detail watermark or is flagged for additional identity checks before the user can download critical assets. For instance, if the user claims to be an established employee but logs in from a new device or location, the system can embed a more conspicuous or layered watermark in the file, making it easier to trace if leaked.

Implementing these deep behavioral modeling techniques requires a robust data collection framework that gathers granular interaction metrics from user sessions. A server-side or client-side agent might capture micro-latencies, app usage transitions, and device characteristics, all fed into a centralized stream-processing pipeline. Libraries such as scikit-learn, PyTorch, or TensorFlow can train classification models or sequence models (e.g., LSTM networks) to profile each user. While high cardinality or real-time inference might benefit from GPU acceleration or distributed computing environments, many organizations can deploy these models incrementally, focusing first on high-risk user groups or sensitive documents.

On the security infrastructure side, companies may integrate hardware security modules (HSMs) or cloud-based KMS solutions to encrypt and protect the raw behavioral data at rest, ensuring it remains private and tamper-resistant. The synergy with existing fraud detection means these advanced behavioral watermarking modules can run side by side with authentication gateways or single sign-on (SSO) systems, receiving risk scores or flagged events as triggers for custom watermark insertion. This unified approach helps organizations maintain consistent security policies across logins, payments, and file distribution, ultimately fostering a more thorough and adaptable defense against insider threats, external attackers, and other unauthorized access.

### Scalability for High-Volume Content

Scalability for high-volume content distribution can be significantly enhanced through AI-driven caching and load-balancing strategies. In many organizations, certain files become “hot spots” of user interest—such as frequently updated financial documents, popular training videos, or repeatedly accessed design specs. By monitoring retrieval patterns, an AI-based module can predict which files are likely to experience heavy loads and proactively create partially watermarked templates or maintain them in a cache of pre-processed content. When a user with the proper credentials requests one of these high-demand files, the system only needs to finalize the user-specific watermark parameters rather than performing a full embedding process from scratch. This predictive caching approach not only reduces latency but also alleviates the computational strain on the core watermarking engine, ensuring that large surges in user demand do not degrade the overall user experience.

Moreover, distributing AI-based watermarking tasks across multiple “worker” nodes or microservices enables a robust, horizontally scalable architecture. In this setup, each worker can run an instance of the necessary machine learning models, either local to a container or orchestrated through a serverless framework. These workers coordinate through a central message queue or load balancer, which directs new watermarking requests to whichever node is least busy at the time. If the system anticipates a major increase in traffic—such as at the release of a high-profile corporate report—auto-scaling policies can spawn additional worker containers on the fly. AI-based orchestration further refines this approach, adaptively distributing tasks in response to real-time analytics of user demand and watermark complexity. Because each worker shares access to the same cryptographic materials (e.g., encryption keys in an HSM) and the same user database, the end-to-end watermark embedding remains consistent and secure.

Implementing these scalability features typically involves container orchestration environments such as Kubernetes or Docker Swarm, where each worker node runs the watermark embedding software, possibly paired with GPU-accelerated instances if handling video or other high-bandwidth media. A specialized module for predictive caching can sit at the front of the architecture, employing ML algorithms to identify usage spikes or to tag frequently accessed content. It may also rely on time-series databases—such as InfluxDB or Prometheus—to store historical request metrics, enabling more accurate forecasting models. Additionally, any cryptographic operations required by the worker nodes can be offloaded to a hardware security module (HSM) or cloud-based key management system (KMS), preventing the overhead of storing or managing keys directly on each node.

An important design consideration is ensuring that each node has identical or suitably synchronized versions of the ML models responsible for generating or refining watermarks. Updates to these models can follow a rolling deployment strategy, avoiding system-wide downtime. Meanwhile, the content or partial-watermark caches can be stored in a distributed in-memory data grid (e.g., Redis or Hazelcast), further reducing retrieval times for popular or large files. The synergy of these architectural components—predictive caching, distributed workers, and secure key handling—facilitates both high throughput and low latency, even under unpredictable spikes in user access demands.

### User Privacy, ZK Proofs, and Confidential Computing

Zero-knowledge proofs (ZK proofs) can enhance user privacy within the dynamic watermarking system by minimizing the amount of personally identifying information that must be transmitted or stored. Even in scenarios where a user must prove their on-chain credentials, advanced AI techniques can help discern patterns of legitimate usage or suspicious activity based purely on cryptographic signals or decentralized identity (DID) interactions. This approach allows the system to confirm that a user is authorized—for example, by verifying zero-knowledge assertions that the user holds a certain membership token—while never learning the token's precise details or the user's personal data. Machine learning can then layer additional checks on top of these minimal disclosures, detecting anomalies or unusual usage patterns within the cryptographic proofs, all without violating the principle of zero knowledge.

Beyond zero-knowledge mechanisms, confidential computing solutions can further ensure that sensitive watermark data or user interaction metrics remain encrypted even during processing. By deploying AI models in secure enclaves—such as those provided by Intel SGX, AMD SEV, or specialized GPU-based trusted execution environments—the system can ingest user data and produce watermark decisions without exposing raw information to the broader host operating system. The embedded watermark, encryption keys, and any user-specific patterns thus remain inaccessible to unauthorized parties, even if the host environment is partially compromised. Taken together, these privacy-preserving measures allow the system to maintain robust forensics, adapt to suspicious usage, and embed tailored watermarks while fully respecting user anonymity and data confidentiality.

When implementing zero-knowledge or privacy-preserving AI modules, organizations often integrate libraries like libsnark, circom, or ZK-STARK-based solutions for verifying membership proofs. The system's AI models, which typically run under frameworks such as TensorFlow or PyTorch, are adapted so that they can accept cryptographic signals—like aggregated DID credentials or partially homomorphic encryption data—instead of cleartext user IDs. An orchestration layer might combine these zkp-based transformations with a real-time queueing system that routes suspicious interactions to a higher-complexity watermark pipeline. Additionally, specialized hardware or virtualized enclaves can isolate the neural network's memory spaces, ensuring that even a root-level attacker on the host machine cannot extract the watermark keys or user data from within the secure enclave.

Computational overhead can rise when using confidential computing or advanced cryptographic proofs. As a result, organizations may invest in GPU-based servers equipped with hardware-accelerated encryption or enclaves that can manage both machine learning operations and cryptographic transformations in parallel. These servers might also rely on distributed caching to reduce the amount of repeated heavy computation. Key generation and management remain tied to a hardware security module (HSM) or cloud KMS, preventing untrusted processes from gaining the secrets needed to decrypt user data or replicate watermarks. Using these combined design elements, the system upholds a strong guarantee of user privacy and data confidentiality while meeting the demands of dynamic watermark embedding, detection, and AI-based anomaly response.

Quantum computing can potentially augment various components of the watermarking systems and methodologies described in this disclosure by strengthening cryptographic operations, accelerating certain forms of data analysis, and adding resilience against future cryptographic vulnerabilities. In particular, it offers prospects for quantum-resistant cryptography. Many of the disclosed embodiments rely on algorithms such as RSA, ECC, or AES, which may be vulnerable to quantum attacks (for example, via Shor's algorithm for factoring or discrete logarithms). By integrating post-quantum primitives based on lattices, error-correcting codes, or similar constructs, the system can ensure that watermarks, encrypted logs, and user credentials remain secure even in the presence of large-scale quantum adversaries. Adopting such quantum-resistant schemes prevents attackers from later decrypting recorded traffic or forging credentials once quantum hardware becomes readily available.

Moreover, quantum computing may assist in AI-driven tasks that appear throughout the watermarking workflow. Certain optimization routines or model-training procedures might run more efficiently on quantum-capable machines, which could help refine how watermarks are placed or how suspicious patterns are clustered among numerous leaked copies. Although fully scalable quantum AI remains an emerging field, hybrid quantum-classical approaches can, in principle, speed up the identification of high-entropy embedding regions or accelerate the grouping of near-duplicate file leaks. If realized, these enhancements allow the system to better handle large multimedia archives and complex user behaviors.

Quantum computing can also provide faster key generation and verification if used in tandem with quantum-based random number generation. The system's watermarking approach often depends on generating fresh cryptographic material for each file request. Secure quantum random number sources improve the unpredictability of those seeds, ensuring that ephemeral keys used to embed and decode watermarks cannot be guessed or regenerated by malicious parties. By combining quantum randomness with the system's dynamic watermarking protocol, each user's session is anchored in robust cryptographic guarantees.

In some embodiments, quantum hardware might facilitate advanced secure multiparty computation. Where partial keys or user context data must be combined from multiple distributed sources, quantum-based protocols could enable participants to reconstruct these keys without revealing them fully to one another. Such approaches might be relevant in organizations or DAOs that require consensus or multi-signature workflows to handle watermark encryption. By weaving quantum-enabled multiparty computation into the watermarking pipeline, different stakeholders can collectively enforce security without any single entity wielding unilateral decryption power.

An equally important dimension is future-proofing the watermarking architecture against cryptographic breaks. As quantum computers mature, classical cryptosystems that remain in use become increasingly at risk. By deploying quantum-ready encryption and hashing routines, the system prevents an attacker from performing a “record now, decrypt later” attack on watermarked content and logs. This aspect is crucial in watermarking because certain forensic evidence, such as the exact identity of a leaker, may be needed years after the original file distribution. Ensuring post-quantum integrity for these records helps maintain their validity long-term.

Although truly large-scale quantum computers are not yet standard, certain technologies are already available. Quantum key distribution (QKD), for instance, can secure communications between the watermark server and a hardware security module or key management service. Meanwhile, near-term quantum co-processors might handle specialized subroutines in AI-based watermark analysis. These partial benefits can be integrated into the existing architecture without fully reconfiguring the system, letting organizations embrace incremental quantum enhancements as hardware capabilities advance.

In terms of implementation, upgrades to post-quantum algorithms require adjustments to cryptographic libraries. Instead of or in addition to classical RSA or ECC, the system may adopt lattice-based solutions such as CRYSTALS-Kyber for key exchange or Dilithium for signatures, or code-based systems like Classic McEliece. The watermark server could also include a quantum random number generator for ephemeral key seeds, ensuring better entropy. Where quantum network devices or QKD infrastructure are available, the server might transmit cryptographic material with quantum-level security for key negotiation. By structurally accommodating these possibilities, the watermarking framework ensures robust traceability and leak detection even in an era of rapidly evolving quantum capabilities.

Various further improvements, embodiments, and applications of the systems and methodologies disclosed herein are also possible. One such enhancement involves extending dynamic watermarking to ephemeral or short-lived content, such as time-limited media files or “self-destructing” documents. In this scenario, each access event could embed a watermark that expires or becomes invalid once the content's viewing window lapses, thereby preventing repeated re-distribution using the same watermark keys. Another embodiment might adopt a more granular real-time embedding process in live streams (e.g., webinar broadcasts or VR sessions), inserting unique, segment-level watermarks as the content is transmitted. This approach ensures that if even a single clip or screenshot leaks, the embedded watermark can be extracted to pinpoint the exact session or viewer responsible.

In highly regulated settings, organizations may integrate the disclosed techniques with advanced policy engines that automatically vary watermark complexity and frequency based on the content's classification level. For instance, a top-secret engineering design could be overlaid with multiple redundant or deeper steganographic watermarks, whereas semi-public content might receive a lightweight watermark. Another variant could incorporate end-to-end encryption—either classically or via post-quantum cryptography—for both the watermark data and the file transmission, ensuring that neither the watermark server nor an intermediate node can access the underlying file without authorization.

Additionally, emerging use cases arise in multi-party data sharing or collaborative analytics scenarios, where multiple organizations or distributed teams collaborate on the same dataset. By employing partial, user-specific watermarks alongside a decentralized identity framework, it becomes possible to track precisely which participant viewed or modified each portion of the dataset—even in contexts where participants only hold cryptographic “shares” of the data. Combining this approach with advanced secure multiparty computation (MPC) methods can produce a system that allows joint processing of sensitive data while still tracing leaks back to specific user addresses if watermarked fragments appear outside the agreed collaboration platform.

Another extension may target the proliferation of immersive media such as augmented reality (AR) or virtual reality (VR) content. Here, the dynamic watermarking logic can embed invisible markers into 3D models, textures, or spatial audio, ensuring that each distributed copy of an AR/VR environment is traceable to a specific access event. The user's hardware or session parameters (e.g., VR headset ID) may also factor into the watermark blueprint, so that content discovered in an unauthorized AR environment can be linked to the exact user device from which it was obtained.

Finally, for security-critical deployments, an organization could combine the dynamic watermarking system with privacy-preserving data techniques such as fully homomorphic encryption (FHE) or advanced zero-knowledge proofs (ZKPs). In effect, a user might prove they hold valid credentials (e.g., membership tokens) and are entitled to a particular dataset without revealing sensitive personal information. The watermark can likewise be inserted in a privacy-friendly manner, ensuring the system never stores or sees raw personal data. These expansions highlight how the disclosure's core mechanisms—dynamic key generation, context-driven embedding, secure logging, and AI-driven analytics—remain flexible and adaptable to many future use cases in digital security, content distribution, and decentralized identity frameworks.

The above description of the present invention is illustrative and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

1-13. (canceled)

14. A system for identifying unauthorized access or leakage of a data file, comprising:
a receiver configured to accept access requests for the data file;
a processor configured to dynamically generate an encryption key based on parameters of the access request, wherein said parameters are selected from the group consisting of the identity of the user, the time of access, and the mode of access;
an embedding module configured to insert a digital watermark into the data file, utilizing the dynamically generated encryption key;
a distribution module configured to provide the watermarked data file to the user;
a secure database configured to store information pertaining to the generated encryption keys and their associated access parameters; and
a decryption and analysis unit configured to decrypt and examine the digital watermark to determine the source of access or leakage in the event of unauthorized distribution.

15. The system of claim 14, wherein the decryption and analysis unit requires authorization credentials, ensuring that only authorized personnel can identify the source of access or leakage.

16. The system of claim 14, wherein the receiver is configured to gather additional contextual data about each access request, including at least one parameter selected from the group consisting of device ID, network IP address, geolocation, and time of day, and wherein said contextual data is used by the processor to further refine the dynamically generated encryption key.

17. The system of claim 14, wherein the processor integrates a user's behavioral attributes, such as keyboard interaction pace, mouse movement frequency, or sequence of actions, into the encryption key generation process, thereby enabling a behavioral watermark that is unique for each user session.

18. The system of claim 14, further comprising an automated policy engine that modifies the encryption key's complexity or length based on a real-time risk score associated with the user's access request, ensuring that higher-risk scenarios receive stronger encryption.

19. The system of claim 14, wherein the embedding module employs a steganographic technique selected from the group consisting of least significant bit (LSB) manipulation, discrete cosine transform (DCT) embedding, or phase-based embedding in audio or video signals, and wherein the processor dynamically chooses the technique based on the detected file format.

20. The system of claim 14, further comprising a hardware security module (HSM) or cloud-based key management service (KMS) that generates or stores the dynamically generated encryption keys, ensuring that unauthorized entities cannot retrieve or tamper with the keys during the watermarking process.

21. The system of claim 14, wherein the distribution module is configured to embed a unique session ID into the watermarked data file alongside the encryption-based watermark, allowing the decryption and analysis unit to trace unauthorized files not only to the user but also to a specific download event.

22. The system of claim 14, wherein the secure database logs the watermark generation event along with time-stamped access credentials, and further publishes a hashed record of the watermark event to a blockchain ledger, creating an immutable reference to the encryption key parameters.

23. The system of claim 14, wherein the decryption and analysis unit is additionally configured to detect attempts to remove or alter the embedded watermark by comparing an integrity hash of the file content to previously stored reference hashes, indicating whether malicious modifications have been performed.

24. The system of claim 14, wherein the receiver filters suspicious requests based on anomalous user behavior or IP address reputations, and instructs the processor to embed a more complex or multi-layered watermark for those suspicious requests.

25. The system of claim 14, further comprising an alerting mechanism that notifies an administrator or third-party monitoring service if the decryption and analysis unit confirms that the discovered watermark corresponds to a user known to be under additional security scrutiny.

26. The system of claim 14, wherein the distribution module implements a streaming-based approach, segmenting large media files and embedding partial watermarks in each segment, so that the decryption and analysis unit can pinpoint precisely which segment was leaked.

27. The system of claim 14, wherein the embedding module integrates an error-correcting code (ECC) into each watermark, thereby ensuring the watermark remains retrievable even after transformations such as compression, resizing, or minor file corruption.

28. The system of claim 14, wherein the processor validates a user's identity via a multi-factor authentication mechanism before generating an encryption key, and adjusts watermark parameters if the user logs in through a less secure or newly registered device.

29. The system of claim 14, further comprising a rules engine that detects repeated unauthorized distributions traced to the same watermark key, and prompts a revocation procedure or key rotation, preventing additional leaks with the same encryption key parameters.

30. The system of claim 14, wherein the secure database implements role-based access controls (RBAC) such that only authorized forensic personnel can retrieve key-generation logs or access the decryption and analysis unit, thereby maintaining strict chain-of-custody over watermark evidence.

31. The system of claim 14, wherein the decryption and analysis unit includes a command-line forensic tool that, when provided with a suspect file, extracts the watermark bits and references the secure database to determine the associated encryption key and user identity.

32. The system of claim 14, wherein the receiver or distribution module is integrated with a content delivery network (CDN) that caches partial watermarked files, enabling lower-latency retrieval while still preserving the unique, user-specific watermark embedded for each access event.

42-456. (canceled)
